(19) United States
(12) Patent Application Publication
(10) Pub. No.: US 2024/0245944 A1
(43) Pub. Date: Jul. 25, 2024

(54) Spin-Air Speaker

(71) Applicant: Fire Jammers Co., Chesterfield, VA (US)

(72) Inventor: James Willis McCaslin, JR., Chesterfield, VA (US)

(21) Appl. No.: 18/418,604

(22) Filed: Jan. 22, 2024

Related U.S. Application Data
(60) Provisional application No. 63/480,900, filed on Jan. 20, 2023.

(51) Int. Cl. A62C 99/00; G10K 15/04

(52) U.S. Cl. CPC A62C 99/0009; G10K 15/04

(57) ABSTRACT

The spin-air speaker is an innovative sound generation and manipulation device, primarily characterized by a modulated spinning disc with a tailored hole pattern and a mechanism for controlled airflow. This technology leverages a precision motor assembly, which includes options such as a stepper motor or a motor/encoder combination, to modulate the disc's rotation speed and pattern. The invention's uniqueness lies in its ability to produce a wide range of sound frequencies and patterns, adjustable through the disc's hole pattern. A notable application of the spin-air speaker is in the field of fire suppression, where it utilizes specific sound frequencies to target and extinguish fires by achieving what is termed a “Pyrosonic lock” on the fire's fundamental and harmonic frequencies. The spin-air speaker's versatility extends to generating musical notes and melodies, and its capability to produce sounds below the human hearing range opens up possibilities for various non-entertainment applications, including but not limited to fire extinguishment.

### CROSS-REFERENCE TO RELATED CASES

This application claims priority to U.S. Provisional Patent Application No. 63/480,900, entitled “Spin-Air Speaker,” filed on Jan. 20, 2023, which is hereby incorporated by reference.

### FIELD OF THE INVENTION

The subject matter relates to the field of acoustic speaker technology, and more specifically to spin-air speakers.

### BACKGROUND

The field of sound generation and manipulation has long been dominated by traditional speaker technology, which relies on the movement of cones or diaphragms to create sound waves. While effective for a range of applications, these traditional methods have limitations in terms of the range and modulation of sound they can produce. Moreover, in specialized applications like fire suppression, conventional speakers are not effective.

Since World War I, sirens have primarily been developed to emit two-tone sounds, typically ranging between 500 and 1500 Hz. In their early iterations, sirens were air-driven devices operated by civil defense members, often positioned on rooftops. The air required for these sirens was generated remotely and piped to the operator, who then directed the sound toward the public.

The design of these sirens evolved from initially using disc-shaped stator chopper combinations to later adopting cylindrical forms. Initially, the disc shape was preferred for its simplicity and effectiveness. However, introducing vanes in the choppers, acting as pumps, caused a significant drag on the chopper, requiring more time for the system to reach the desired frequency. As a result, the isolated air supply systems, possibly driven by bellows, were replaced by hand cranks and motors when they were integrated closer to the horn assembly.

This change reflected the lack of necessity for rapid frequency changes in public alert applications. With the integration of pumps into the siren design, cylindrical shapes became the preferred choice for manufacturers.

Stepper Motors: Stepper motors have revolutionized precision-controlled mechanical movements. Their ability to move in exact increments makes them ideal for applications requiring precise control and repeatability, extending from robotics to innovative sound generation methods in the Spin-Air Speaker technology.

Sound-Based Fire Extinguishing Research. In the realm of fire suppression, there has been exploratory research, notably in academic settings, into using sound waves, particularly at low frequencies, to extinguish fires. The underlying principle involves using these sound waves to disrupt the air around a fire, cutting off the oxygen supply or disturbing the combustion process. While the concept shows promise and potential applications in specific environments (such as in space), it remains largely experimental and is still being developed to understand its efficacy in different fire scenarios.

This historical evolution of siren technology, particularly in terms of its design and functional objectives, provides an insightful backdrop to the development of the Spin-Air Speaker. The invention leverages this rich history of acoustic design, integrating modern advancements in motor technology and sound-based fire extinguishing methods, to create a novel approach to sound generation and control.

Thus, there exists a need for sound generation technology that enables the precise modulation of sound, particularly in the lower bands of audio, and below, and that can be adapted for unique applications such as extinguishing fires.

### SUMMARY OF THE INVENTION

In an embodiment, a spin-air speaker represents a significant advancement in sound generation technology by using a disc with a pattern of openings, spun at precisely modulated speeds and coupled with a controlled airflow mechanism, to produce a wide range of sound patterns. The technology is uniquely designed to operate effectively in the lower bands of audio and even below the human hearing range, making it suitable for specialized applications such as fire suppression.

In an embodiment, precision motor control, utilizing technologies such as stepper motors or motor/encoder combinations, enables the fine modulation of the rotation of the disc. This approach allows for an unprecedented level of control over sound production, diverging from the traditional sound generation methods and embracing the precision offered by modern motor technology.

In an embodiment, a spin-air speaker and system generate audible tones such as music.

In an embodiment, a spin-air speaker and system generate modulated sounds in a pattern capable of extinguishing fires.

In an embodiment, two controlled plates working together in one unit would give an optimized hole pattern the ability within a spin-air speaker system the freedom to generate an extremely wide frequency bandwidth. These two controlled opposing plates driving against one another would be capable of generating controlled sound wave frequencies above and below the range of 20 Hz to 20 KHz.

### BRIEF DESCRIPTION OF THE DRAWINGS

The embodiments are illustrated by way of example and not limitation in the accompanying drawings, in which like references indicate similar elements, and in which:

FIG. 1 is a schematic illustrating an embodiment of a spin-air speaker incorporated into an embodiment of a system for extinguishing fires;

FIG. 2A is a side view of elements from the system for extinguishing fires of FIG. 1;

FIG. 2B is a perspective view of the elements of FIG. 2A;

FIG. 3A is a perspective view of elements from the system for extinguishing fires of FIG. 1;

FIG. 3B is a bottom view of the elements of FIG. 3A;

FIG. 4A is a perspective view of elements from the system for extinguishing fires of FIG. 1;

FIG. 4B is a side view of elements from FIG. 4A;

FIG. 4C is a bottom view of the elements of FIG. 4A;

FIG. 5A is a side view of elements from the system for extinguishing fires of FIG. 1;

FIG. 5B is a perspective view of the elements of FIG. 5A;

FIG. 5C is a bottom view of the elements of FIG. 5A;

FIG. 5D is a bottom view of selected elements of FIG. 5A;

FIG. 6 is a schematic illustrating aspects of the system for extinguishing fires of FIG. 1;

FIG. 7 is an illustrating of an embodiment of a system for extinguishing fires;

FIG. 8A-FIG. 8D are side views of elements from embodiments of spin-air speakers;

FIG. 8E-FIG. 8H are top views illustrating aspects of elements from embodiments of spin-air speakers;

FIG. 9A is a perspective view of aspects of an embodiment of a spin-air speaker;

FIG. 9B is a partial assembly view of the embodiment of the spin-air speaker of FIG. 9A;

FIG. 10 is a schematic illustrating an embodiment of a spin-air speaker incorporated into an embodiment of a system for producing sounds;

FIG. 11 is a schematic illustrating an embodiment of a spin-air speaker incorporated into an embodiment of a system for producing sounds;

FIG. 12A is a schematic and images illustrating aspects of an embodiment of a spin-air speaker;

FIG. 12B includes images illustrating aspects of an embodiment of a spin-air speaker of FIG. 12A;

FIG. 13A is a side view illustrating a system for producing the images of FIG. 12A and FIG. 12B;

FIG. 13B is a front view of aspects of the system of FIG. 13A;

FIG. 14A is an upper front right perspective view of an embodiment of a spin-air speaker incorporated into a system for extinguishing fire;

FIG. 14B is an upper rear perspective view of the system of FIG. 14A;

FIG. 15 is a chart illustrating results produced by the system of FIG. 14A;

FIG. 16 is an illustration of aspects of sounds produced by an embodiment of a system for extinguishing sound;

FIG. 17 is a schematic illustrating a use case for the system of FIG. 1 and illustrating aspects of sounds produced by the embodiment;

FIG. 18A and FIG. 18B are spectra illustrating aspects of sounds produced by an embodiment of a system for extinguishing fire;

FIG. 19A-FIG. 19D are spectra illustrating aspects of sounds produced by an embodiment of a system for extinguishing fire;

FIG. 20A is a screenshot from an embodiment of a system for extinguishing fire;

FIG. 20B is a schematic of the embodiment of the system for extinguishing fire of FIG. 20A;

FIG. 21 is a screenshot showing test results from an embodiment of a system for producing sounds;

FIG. 22 is a composite image of a calibration of an embodiment of a system for producing sounds;

FIG. 23 is an exemplary block diagram depicting an embodiment of a system for implement embodiments of methods of the disclosure; and

FIG. 24 is an exemplary block diagram depicting a computing device of an embodiment of a system.

### DETAILED DESCRIPTION

In an embodiment, a fire-extinguishing system uses modulated sounds from a spin-air speaker to extinguish fire. It is now possible to create kits capable of converting generic leaf blowers into sound-based mobile fire extinguishers. In an embodiment, a sound-generating system uses a spin-air speaker to create and modulate sounds as desired by the user.

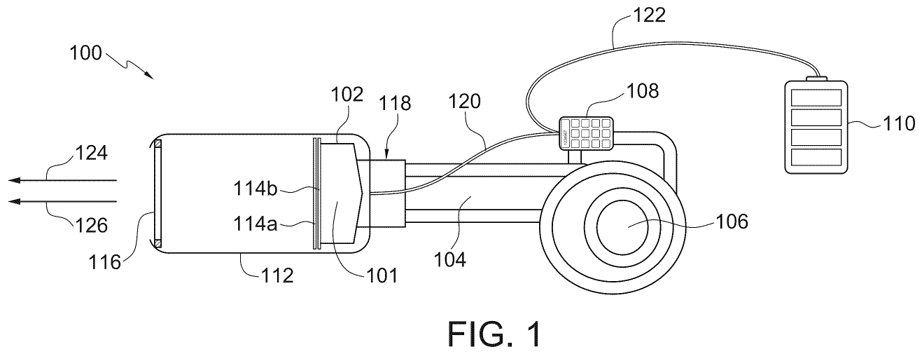

FIG. 1 is a schematic illustrating an embodiment of a spin-air speaker 101 incorporated into an embodiment of a system 100 for extinguishing fires. System 100 includes a blower 106 having a tube 104 connected to spin-air speaker 101. Spin-air speaker includes a housing 102 containing plates 114a, 114b rotatably mounted within housing 102 to a motor, each plate containing a pattern of openings. Blower 106 may include a leaf blower and be connected to housing 102 using a clamp, e.g., a hose clamp, at a position 118. A sleeve 112, called a “vortex sleeve”, is connected to housing 102 and directs airflow 124 through a nozzle ring 116. Blower 106 and spin-air speaker 101 may be controlled over communication links, e.g., communication link 120, by controller 108, which includes, e.g., a CPU, circuitry, and a keyboard accepting user input. Blower 106, spin-air speaker 101, and controller 108 are connected by a power connection 122 to a power supply 110, in this embodiment a battery that may be carried by a user. Control of blower 106 includes controlling the flow rate of an airflow 124. Control of spin-air speaker 101 includes controlling the spin rate of a plate 114a or 114b, each containing a pattern of openings. In the embodiment, when blower 106 is creating airflow 124 and at least one of plates 114a, 114b is spinning, system 100 creates sound 126, which may be modulated in frequency by controller 108 changing the speed at which the disc or discs are spinning and modulated in volume by controller 108 changing the amount of airflow 124. Because airflow 124 passes through the perforated pair of plates, one of which is spinning, the total area through which airflow 124 may pass changes based on the speed of relative rotation of the plates and the geometries of the openings in each plate. As a result, each perforated plate 114a, 114b may be called a “chopper,” which is descriptive of the change in the degree of overlap of opposing openings in the plates—as the pair align and then mis-align the flow allowed between them is allowed and then “chopped” off.

In the embodiment, tube 104 provides a back chamber for spin-air speaker 101 and sleeve 112 functions as a vortex generator. In an embodiment, sleeve 112 had following dimensions, which were found to optimize the extinguishing effect, i.e., decrease the time required to extinguish the flame: length is 300 mm and outlet diameter is 100 mm.

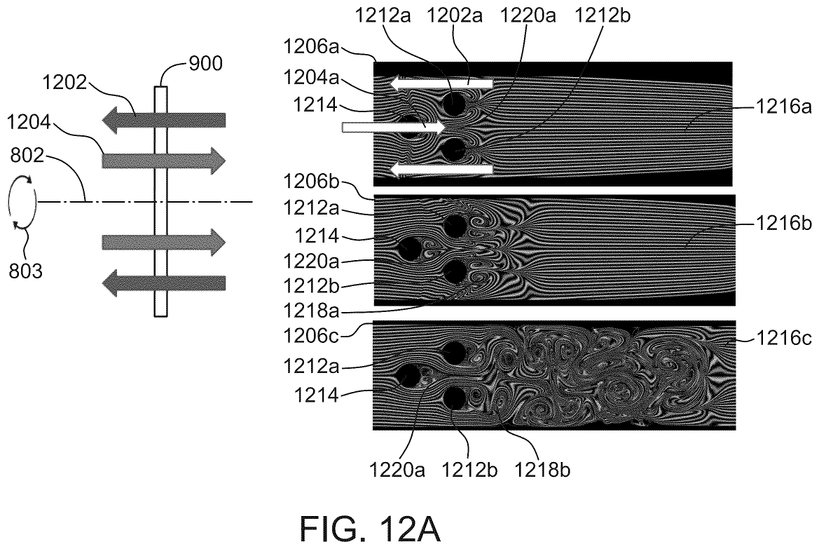

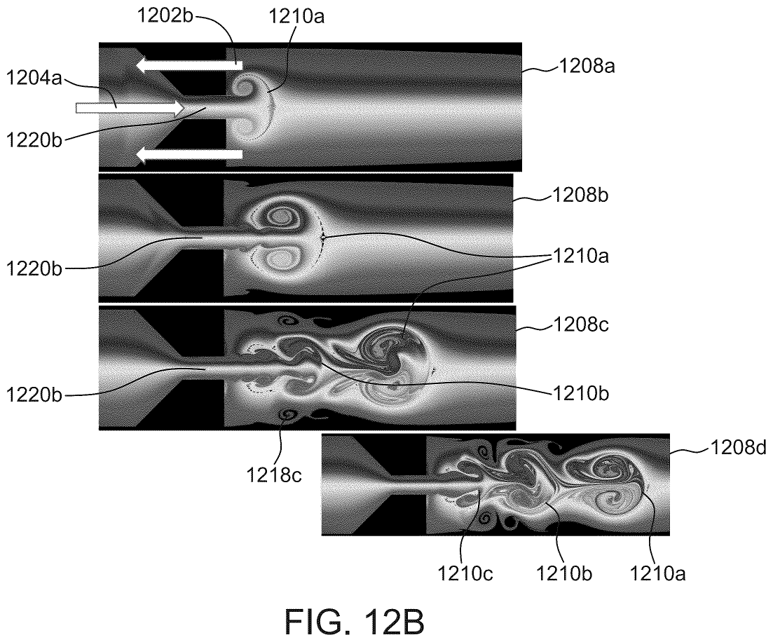

The back chamber provided a reserve for the air pressure to build up behind plates 114a, 114b when the openings are closed. The longer the tube, the greater the volume of the back chamber, which enhances the intensity of sound waves and airflow (see FIG. 12A and FIG. 12B) created when openings align and provide greater flowpath area.

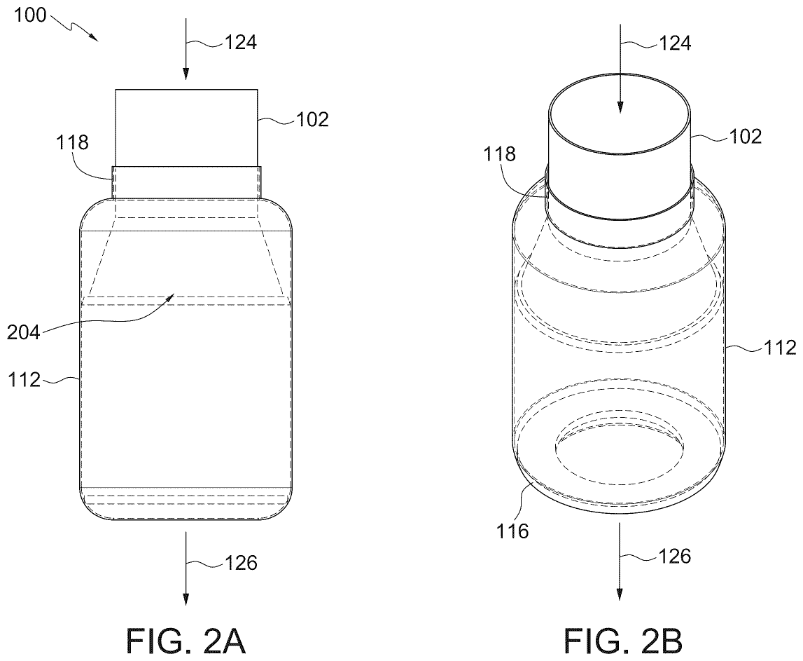

FIG. 2A is a side view of housing 102, sleeve 112, and nozzle 116 from system 100. In an embodiment, the length of sleeve 112 is based on a theoretical lower frequency ¼ wave reflection point from the chopper and back through the person or apparatus holding the spin-air speaker. Approximately 3.1′ length is preferable to reflect 100% of what is expected to be the fire extinguishing harmonics FIG. 2B is a perspective view of the elements of FIG. 2A. FIG. 2A and FIG. 2B illustrates that, in the embodiment, sleeve 112 may be clamped to housing 102, e.g., also at location 118. Plates 114a, 114b are located just within mouth 204. When airflow 124 passes through plates 114a, 114b and one of them is spinning, sound 126 is created. As airflow 124 passes through nozzle 116 a vortex is created in addition. The space within sleeve 112 between nozzle 116 and mouth 204 provides a forward pressure chamber that produces a vortex puff in addition to the sound output. (See FIG. 12A and FIG. 12B.)

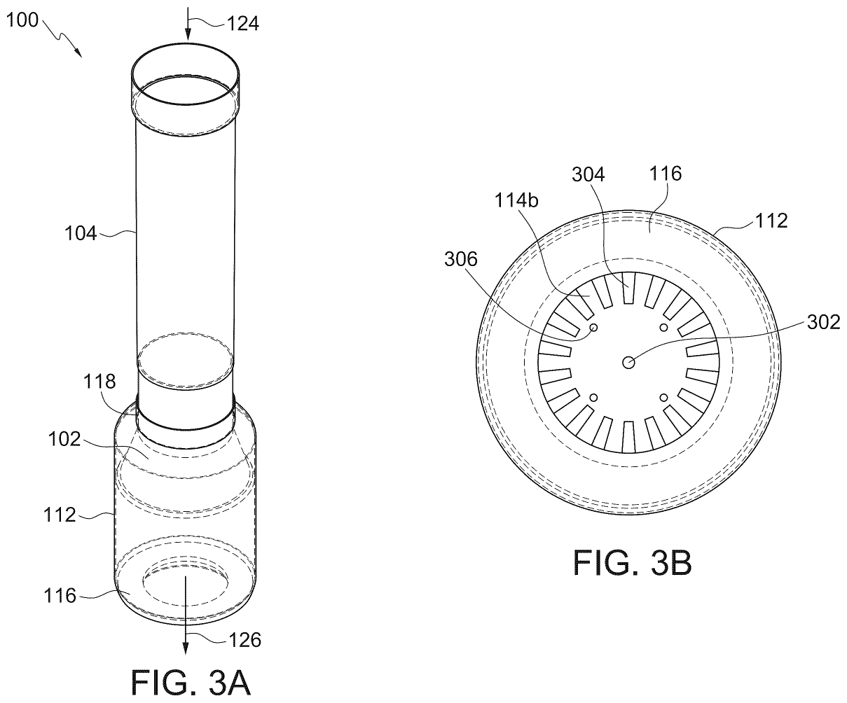

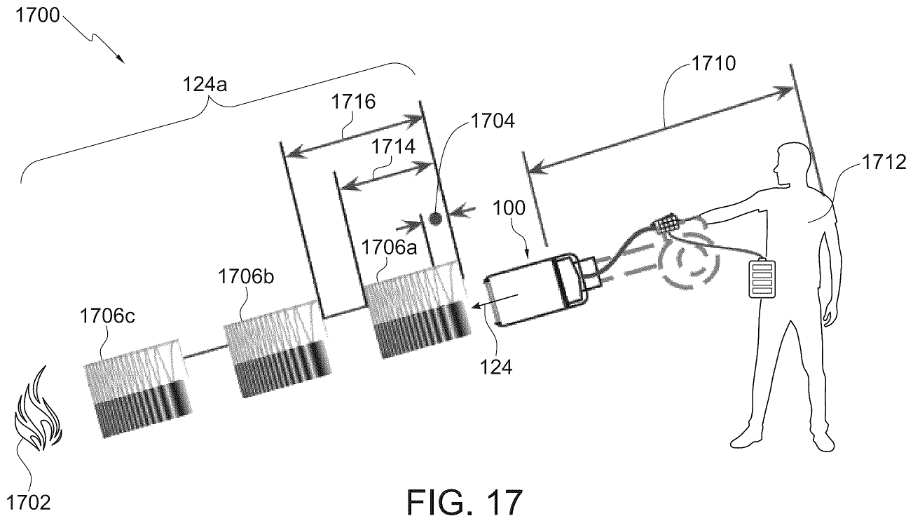

FIG. 3A is a perspective view and FIG. 3B is a bottom view of elements from system 100. In FIG. 3B, lower plate 114a has been removed, making upper plate 114b visible through nozzle 116. Plate 114b is shown to include openings 304 in a pattern about a motor drive axle 302. Plate 114b is fastened to the motor 404 through mounting plate 410. Thus, in this embodiment, plate 114b, which is proximate to the motor, is non-rotating and plate 114a, which is distal from the motor, is the rotating plate. In an embodiment, the lower the frequency of sound being output, the greater the strength the reflective walls (i.e., faces of plates 114a, 114b, and sides of tube 104) should be to more efficiently redirect the wavelength. For example, with spin-air speaker 101, flat, stainless-steel discs were selected the reflective surface available for this use case was directly behind the chopper—the reflective surfaces include the sides of tube 104 and also the person holding it. (See FIG. 17.)

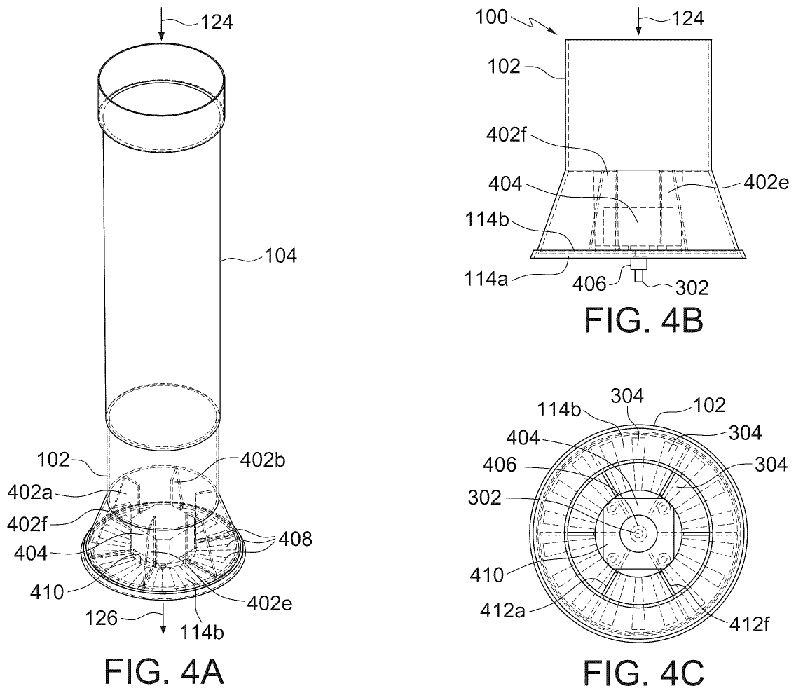

FIG. 4A, FIG. 4B, FIG. 4C are partially transparent perspective, side, and bottom views, respectively, of elements from system 100 for extinguishing fires. FIG. 4A illustrates that housing 102 contains a motor 404, e.g., a stepper motor, connected to a mounting plate 410 and to plate 144b, and provided between vanes 402a . . . 402f. Vanes 402a . . . 402f contact motor 404 and may be connected to both plate 114b and housing 102 to enhance structural rigidity. Vanes 402a . . . 402f are located upstream in airflow 124 from plate 114b to help maintain linear flow in airflow 124. FIG. 4B illustrates that lower plate 114a is connected to axle 302 of motor 404 and fixed in place with a collet 406. FIG. 4C shows spokes 412a . . . 412f that extend from mounting plate 410 to housing 102. In the embodiment, lower plate 114a has openings of the same shape and pattern as openings 304 of plate 114b. In other embodiments, the openings on the plates may be dissimilar, and may be shaped differently from openings 304.

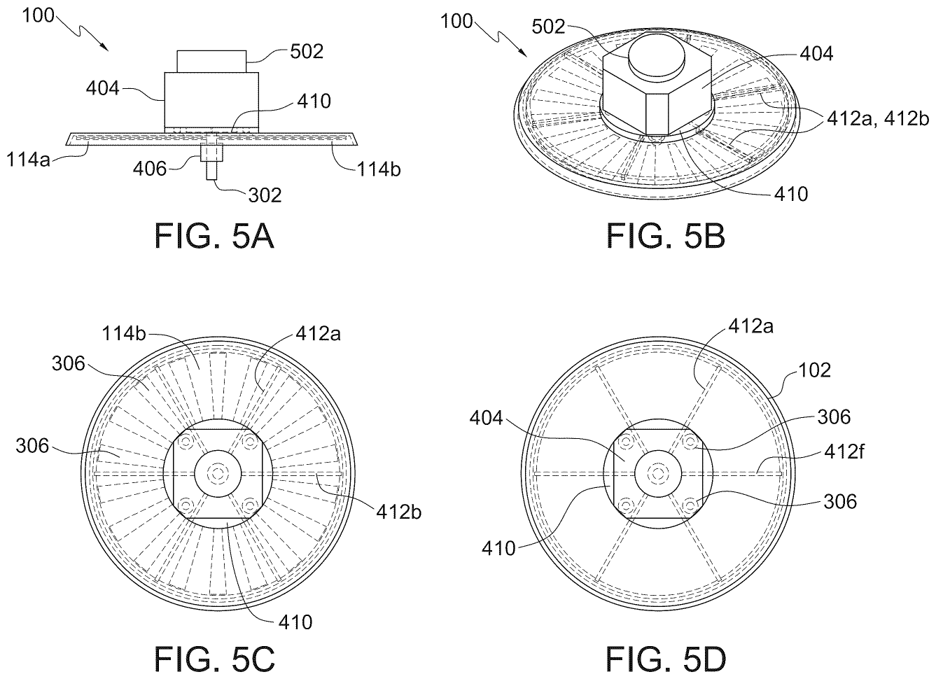

FIG. 5A-FIG. 5D are side, perspective, bottom, and bottom views, respectively, of elements from system 100 for extinguishing fires. In FIG. 5D, plates 114a, 114b are omitted. In particular, these figures are directed to elements of spin-air speaker 101. FIG. 5A illustrates that motor 404 may receive drive signals from an encoder 502 in embodiments in which motor 404 is a synchronized motor. FIG. 5B-FIG. 5D illustrates spokes 412a . . . 412f extending from mounting plate 410. In an embodiment, spokes 412a . . . 412f align with vanes 402a . . . 402f.

In an embodiment, plates 114a, 114b may be stainless steel discs. In other embodiments, the plates may be fashioned of different materials. In the embodiment, collet 406 may have a D-shaped center hole corresponding to a flat on axle 302 and the mounting hole in plate 114a. In other embodiments, collet 406 may be replaced with a threaded nut. In embodiments in which plates 114b is flexible, plate 114b may be sandwiched between washers when mounted.

In an embodiment, the upstream plate is made of flexible material such that when an airflow is applied the upstream plate collapses against the downstream plate, which results in all airflow having to pass through an overlap of two plate openings, and not between two plates. Thus, such an embodiment may provide sounds that are more pure by way of having eliminated unwanted paths for airflow.

In embodiments, spin-air speaker technology uses a spinning plate, with the spin modulated by precision motor control movements. The plate features a pattern of openings, which, when rotated at various speeds and modulations, and when an airflow is forced through the openings, generates a range of sound frequencies where the sound frequency varies with the speed of rotation and where changing the speed of rotation and the airflow may be used to create sounds in desired patterns of frequency and amplitude. In embodiments, modulations involve altering one or more of amplitude, frequency, or phase, in accordance with the information (or signal) that needs to be transmitted. The spinning disc of the spin-air speaker has control over frequency and phase which became instrumental in controlling flames. The amplitude is controlled by airflow. The information (or feedback signal visually observed) is what was needed to be transmitted from the pattern of fire back to the person or device controlling the spin-air speaker. In embodiments, plates with different sizes of opening and patterns of openings may be used to change the range of frequencies that may be produced, and to change the speeds of rotation that may be used to produce a particular frequency. Thus, in embodiments, plates may be customized through the variation of disc sizes, shapes (e.g., geometric shapes other than circular), and hole patterns. This adaptability makes spin-air speakers suitable for applications requiring a wide range of frequencies, from high-frequency sounds to low-frequency pulses, e.g., for fire suppression.

In some embodiments a stepper motor, which can be programmed to move in precise increments, may be used to control the rotation of the disc. Such a motor may be programmed for both high-speed rotations and slower, more precise movements, which enables the system to produce sound frequencies across a wide range and accurately. In some embodiments a combination of synchronized motor and encoder may be used to provide a level of precision similar to that of a stepper motor. A motor/encoder combination uses a sensor to track the motor's shaft position, offering another dimension of precision in controlling the disc's rotation.

A feature provided by the stepper motor and the motor/encoder combination is the ability to rapidly modulate the speed of the plate rotation. Rapid plate modulation may be used to achieve the effects of traditional speaker cones by controlling the acceleration and deceleration of the plate in combination with an airflow being forced through openings within the plate. The changes in plate rotation speed alter the way air is split, creating the desired sound effects. A feature of embodiments is that volume is determined by airflow. Thus, musical notes may be created with an airflow as light as a gentle breeze, while more powerful airflows may be used to create high decibel warnings. Audible notes are controlled by rapidly changing rotational rates.

In an embodiment for extinguishing fires, the hole pattern selected was based on the maximum amount of available airflow available to produce low frequency pulses. To produce relatively higher frequencies, an embodiment may select relatively smaller openings and opening patterns that provide for less airflow, which results in higher pressure differences across the plates and resulting higher frequency ranges, given a certain range of rotation speeds. In embodiments, the hole size area for all of the holes combined was driven by the desire to avoid constraining the available airflow. The trapezoid open then close pattern was selected to minimize the impact on the airflow.

In an embodiment, a second spin air speaker may be mounted in opposition to the first spin-air speaker in housing 102, thus having two, independently controllable spinning plates 114a. The combination allows for improved frequency response due to the ability to increase the relative rate of change of the hole patterns in one spinning plate with respect to hole patterns in the other spinning plate. In an embodiment, when two spin-air speakers are mounted in opposition, the non-spinning plates may be eliminated. This allows the spinning plates to be brought closer together. By eliminating the non-spinning plates between the spinning plates, the size of the openings through which air may flow is determined by the overlap of the openings of the two spinning plates. Thus, the embodiment may provide a spin-air speaker with a faster response time, and with a more precise control over the frequency produced. In other words, The sharper and tighter the “chop,” the crisper the frequency that is generated.

In some embodiments, the spinning plate may be placed on the high-pressure side of the chamber, e.g., when the plate material is flexible. In embodiments, sound may be created using sources of airflow that are located downstream of the plates and drawing the airflow through the plates by creating a vacuum between the plates and the blower.

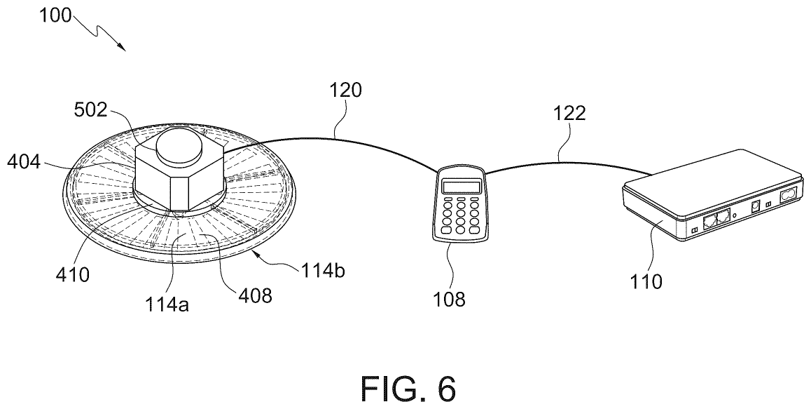

FIG. 6 illustrates that controller 108 receives power over link 122 and powers and controls the speed of the spinning plate 114a through link 120. In FIG. 6, controller 108 may be controlled by an electronics package based on the adaptation of 3D printing robotic circuitry and software controls. This package preferably controls the motor and the motor provides enough torque to rapidly change the rotational speed of the spinning plate, which includes changing the speed of the spinning plate within a single rotation.

Formula for determining the frequency output of an embodiment of a spin-air speaker, e.g., spin-air speaker 101:

$$Output Hz of speaker = ( \# of evenly spaced plate openings / plate ) * ( rotations of plate / second ) \qquad Eq . 1$$

$$Output Hz of speaker = ( ( Steps + Cal Steps ) / Rev ) * ( rotations of plate / second ) \qquad Eq . 2$$

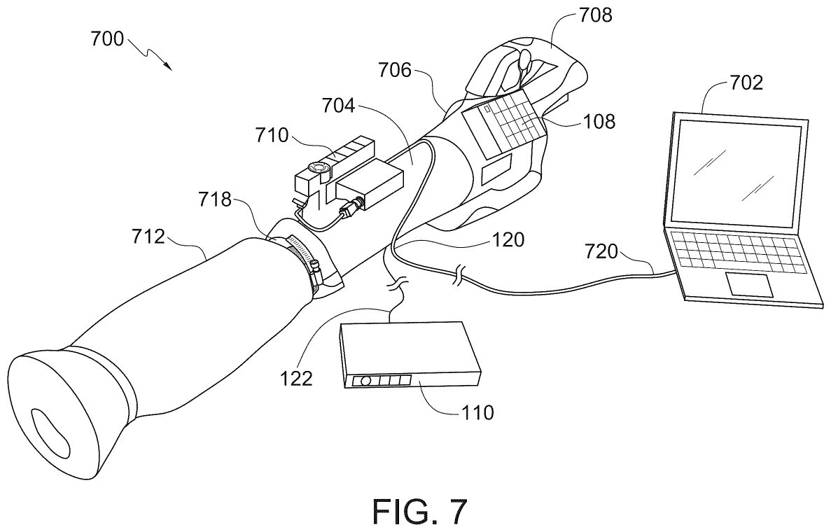

FIG. 7 is an illustration of an embodiment of a system 700 for extinguishing fires. In FIG. 7, system 700 includes a blower 706 having a tube 704 connected to spin-air speaker, e.g., spin-air speaker 101 (e.g., FIG. 1-FIG. 6) connected to tube 704 by hose clamp 718 and contained within sleeve 712. In the embodiment, blower 706 includes a commercially available leaf blower including a handle 708. A second handle 710 may be attached to tube 704 for additional control of the device. Sleeve 712, called a “vortex sleeve,” is connected to spin-air speaker 101 and directs airflow through a nozzle ring 116 (FIG. 1). Blower 706 and spin-air speaker 101 may be controlled over communication links, e.g., communication link 120, by controller 108. Blower 706, spin-air speaker 101, and controller 108 are connected by a power connection 122 to a power supply 110, in this embodiment a battery that may be carried by a user. Control of blower 706 includes controlling the flowrate of the airflow. In the embodiment, when blower 706 is creating airflow and at least one of plates 114a, 114b is spinning, system 700 creates a sound, the frequency of which may be modulated by controller 108 changing the speed at which the disc or discs are spinning and modulated in volume by controller 108 changing the amount of airflow created by blower 706. A computing system 702 may be connected to controller 108 by a communication link 720 and used to program controller 108.

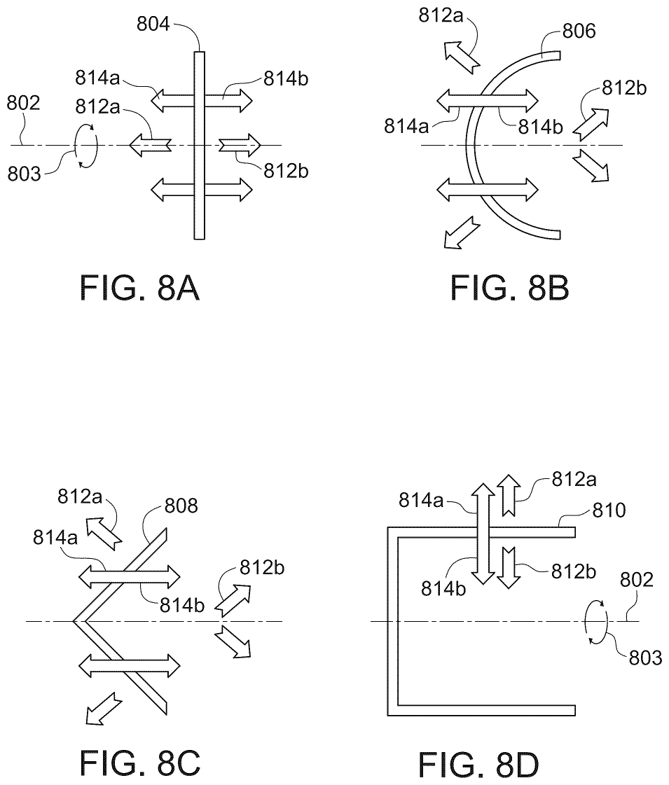

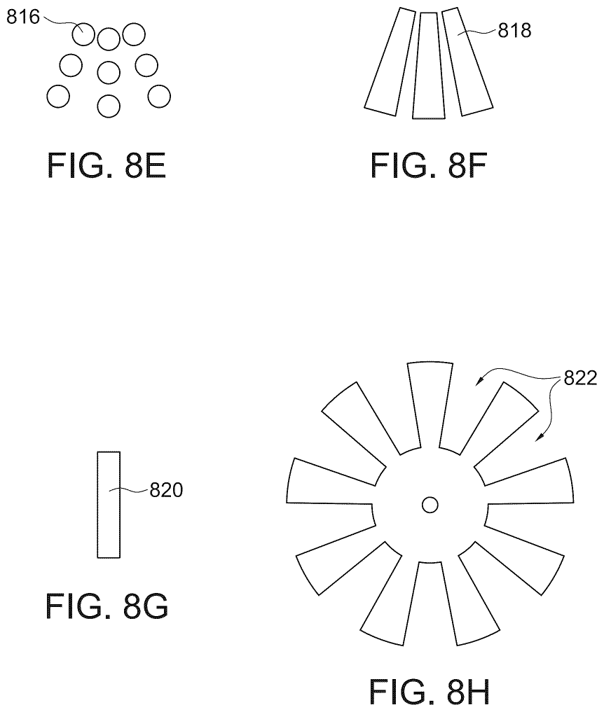

FIG. 8A-FIG. 8D are side views of plates from embodiments of spin-air speakers. In these figures, each plate is oriented to spin about a common axis 802 in a common direction of rotation 803. Each plate is symmetrical above and below axis 802 and the description of the top half will apply equally to the bottom. FIG. 8A depicts a disc-shaped plate 804. FIG. 8B depicts a dome-shaped plate 806. FIG. 8C depicts a cone-shaped plate 808. FIG. 8D depicts a cylindrically-shaped plate 810. For each plate, airflows 814a, 814b illustrate directions of airflow through openings in the plate, either of which may be used to create sound with corresponding spinning of one plate with respect to a second similarly-shaped plate provided with openings (not necessarily similarly shaped) of its own. For each plate soundwave apexes 812a, 812b represent directions of soundwaves emitted by the speaker, with apex 812a created by airflow 814a and apex 812b created by airflow 814b.

FIG. 8E-FIG. 8G are top views illustrating embodiments of patterns of openings that may be provided in a plate, e.g., any of plates 802 . . . 810. FIG. 8E illustrates round holes 816 that may emanate radially from a center axis, e.g., axis 802 or be provided on a plate in other orientations. FIG. 8F illustrates trapezoidal openings 818 that may emanate radially from a center axis, e.g., axis 802 or be provided on a plate in other orientations. FIG. 8G illustrates rectangular slots 820 that may emanate radially from a center axis, e.g., axis 802 or be provided on a plate in other orientations. FIG. 8H illustrates open slots 822 that may emanate radially from a center axis, e.g., axis 802. In embodiments openings of other shapes may be provided in a plate.

In an embodiment, it was the direction and reflection of the perceived apex of the sound waves that determined the shape of this ongoing effort. Other shapes will work fine for most audible frequencies. However, with spin-air speaker 101, the focus was on the lower audible frequency bands and below.

In an embodiment, the openings within a plate may be configured to maximize the available airflow associated with a “puff” (a “puff” is described further with reference to FIG. 12A and FIG. 12B), particularly a “puff” associated with a relatively low frequency sound. In embodiments, relatively higher frequency ranges may be obtained with smaller holes and higher plate rotation speeds.

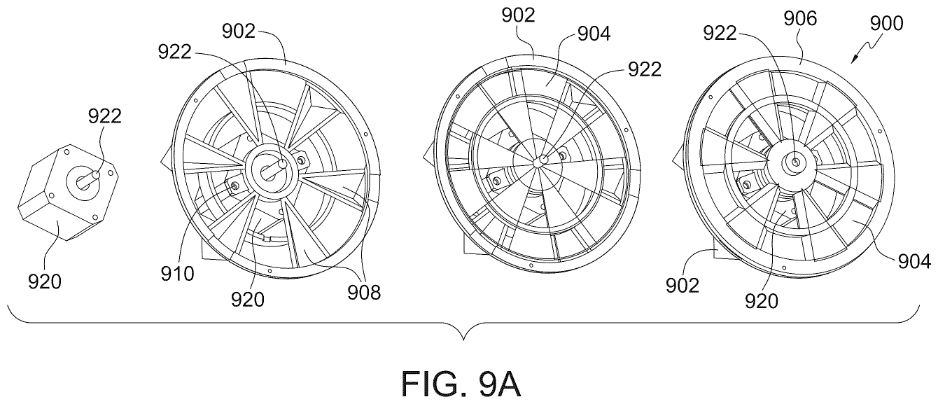

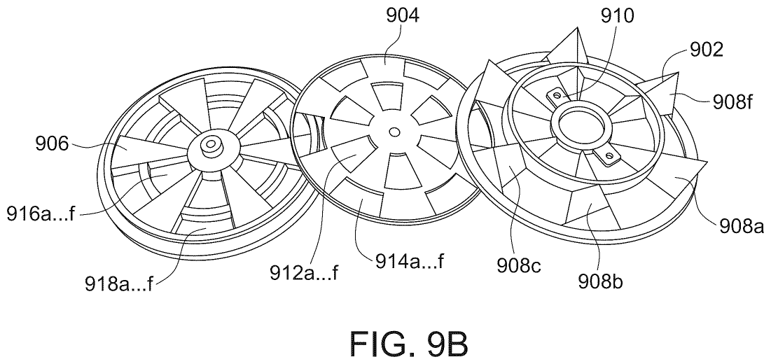

FIG. 9A is a perspective view of aspects of an embodiment of a spin-air speaker 900. FIG. 9B is a partial assembly view of spin-air speaker 900. In FIG. 9A and FIG. 9B, spin-air speaker 900 includes a motor 920 with a drive axle 922. Motor 920 is mounted using fasteners 910 to a base plate 902 including vanes 908a . . . 908f. Vanes 908a . . . 9087f are shaped to direct airflow between the vanes by being narrower in an upstream part and wider at a downstream part. A first plate 904 having a first pattern of openings is mounted to axle 922. The first pattern of openings includes an outer group 914a . . . 914f and an inner group 912a . . . 912f with the inner and outer groups being staggered. A second plate 906 having a second pattern of openings is then mounted to axle 922. The second pattern of openings includes an outer group 918a . . . 918f and an inner group 916a . . . 916f with the inner and outer groups being aligned along common radii. In an embodiment, plate 904 spins and plates 902 and 906 are stationary. FIG. 9A illustrates an embodiment with a closed outer chamber and an open inner chamber. The embodiment illustrates that various hole patterns may be combined to create different frequencies.

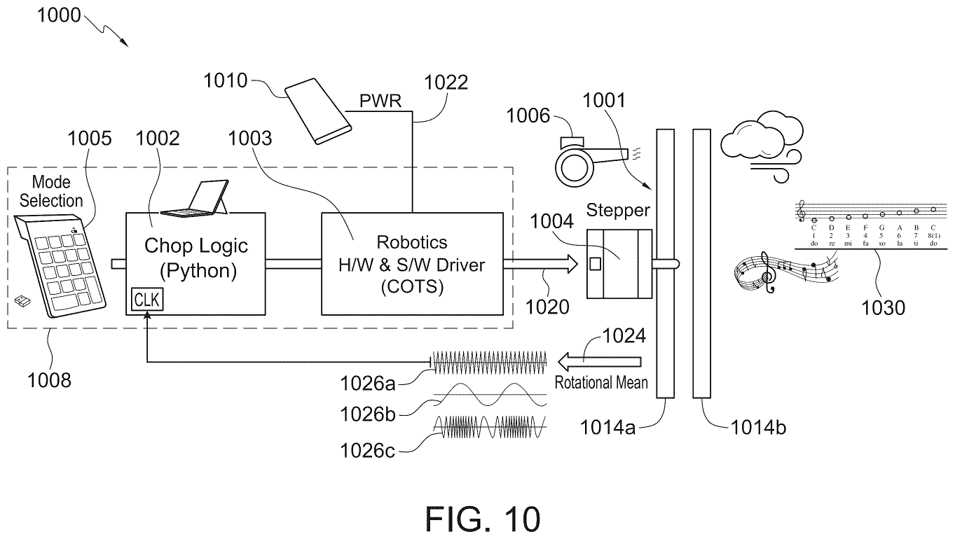

FIG. 10 is a schematic illustrating an embodiment of a spin-air speaker incorporated into an embodiment of a sound generator 1000. Sound generator 1000 includes a blower 1006 directing an airflow to spin-air speaker 1001. Spin-air speaker 1001 includes plates 1014a, 1014b. Plate 1014a is mounted to a motor 1004, in this embodiment a stepper motor. Although, not depicted, each plate 1014a, 1014b includes a pattern of openings, e.g., such as any of the patterns illustrated in FIG. 8A, et seq. Blower 1006 may include a leaf blower. Blower 1006 and spin-air speaker 1001 may be controlled over communication links, e.g., communication link 1020, by controller 1008, which includes, e.g., a user interface/keyboard 1005, a logic module 1002, and a stepper motor driver 1003. Blower 1006, spin-air speaker 1001, and controller 1008 are connected by a power connection 1022 to a power supply 1010, in this embodiment a battery that may be carried by a user. Control of blower 1006 includes controlling the flowrate of airflow from blower 1006. Control of spin-air speaker 1001 includes controlling the spin rate of a plate 1014a. In the embodiment, when blower 1006 is creating an airflow and plate 114a is spinning, system 1000 creates sounds 1030, which may be modulated in frequency by controller 1008 changing the speed at which the disc or discs are spinning and modulated in volume by controller 1008 changing the amount of airflow. Thus, using interface 1005, a series of sounds at different frequencies may be created and their volume modulated by changing the airflow. Because airflow passes through the perforated pair of plates, one of which is spinning, the total area through which airflow may pass changes based on the speed of relative rotation of the plates and the geometries of the openings in each plate. In the embodiment, logic module 1002 may include a python code and motor driver 1003 may be based on existing robotics hardware and software drivers. In an embodiment, plates 1014a, 1014b may include a pattern of openings, e.g., as described with respect to spin-air speaker 101 or with regard to FIG. 8A, et seq., and plate 1014a may be driven at rotational speeds that allow speaker 1001 to have an output of from 3 Hz to 20 kHz. Although not shown in FIG. 10, in embodiments, sound generator may include components such as tube 104 to direct airflow from blower 1006 through spin-air speaker 1006.

In FIG. 10, a rotational mean 1024 signal may be fed back as clock input to logic module 1002. The rotational mean signal 1024 may by used to confirm that plate 1014a is spinning at a target signal, e.g., such as a target signal intended to cause speaker 1001 to generate a sound frequency, such as a frequency indicated by any of waveforms 1026a . . . 1026c.

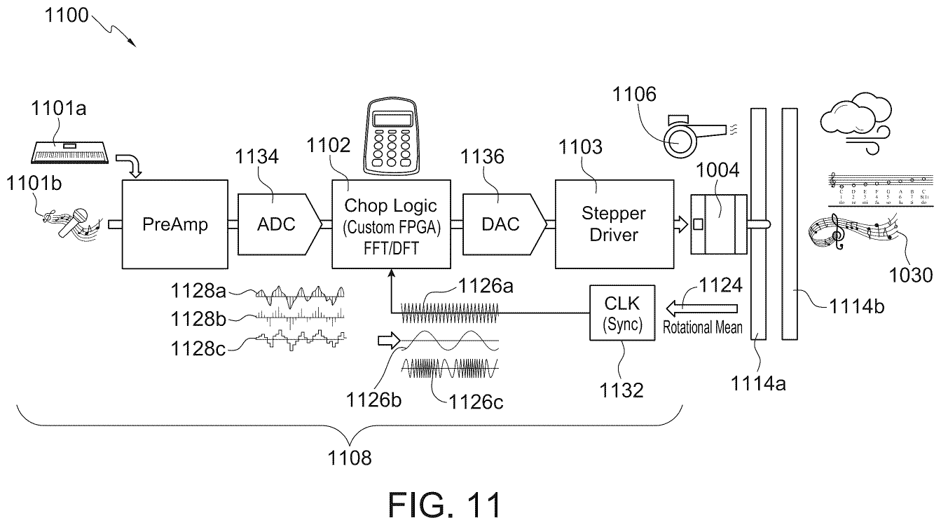

FIG. 11 is a schematic illustrating an embodiment of a spin-air speaker incorporated into an embodiment of a sound generator 1100. Sound generator 1100 includes a blower 1106 directing an airflow to spin-air speaker 1101. Spin-air speaker 1101 includes plates 1114a, 1114b. Plate 1114a is mounted to a motor 1104, in this embodiment a stepper motor. Although, not depicted, each plate 1114a, 1114b includes a pattern of openings, e.g., such as any of the patterns illustrated in FIG. 8A, et seq. Blower 1106 may include a leaf blower. Blower 1106 and spin-air speaker 1101 may be controlled over communication links similar to communication link 1020, by controller 1108, which includes, e.g., an interface (such as a keyboard 1101a or microphone 1101b), a preamp, an analog to digital converter 1134, a logic module 1102 (e.g., a custom Field Programmable Gate Array (FPGA) with FFT Fast Fourier Transform (FFT) and Discrete Fourier Transform (DFT), which are mathematical techniques used in signal processing to analyze the frequencies contained within a signal), a digital-to-analog converter 1136, and a stepper motor driver 1103. Blower 1106, spin-air speaker 1101, and controller 1108 may be connected by a power connection to a power supply, in this embodiment a battery that may be carried by a user. Control of blower 1106 includes controlling the flow rate of airflow from blower 1106. Control of spin-air speaker 1101 includes controlling the spin rate of a plate 1114a. In the embodiment, when blower 1106 is creating an airflow and plate 114a is spinning, system 1100 creates sounds 1130, which may be modulated in frequency by controller 1108 changing the speed at which the disc or discs are spinning and modulated in volume by controller 1108 changing the amount of airflow. Thus, using an interface, e.g., 1101a, 1101b, a series of sounds at different frequencies may be created and their volume modulated by changing the airflow. Because airflow passes through the perforated pair of plates, one of which is spinning, the total area through which airflow may pass changes based on the speed of relative rotation of the plates and the geometries of the openings in each plate. In the embodiment, logic module 1102 may include a python code and motor driver 1103 may be based on existing robotics hardware and software drivers. In an embodiment, plates 1114a, 1114b may include a pattern of openings, e.g., as described with respect to spin-air speaker 101 or with regard to FIG. 8A, et seq., and plate 1114a may be driven at rotational speeds that allow speaker 1101 to have an output of from 3 Hz to 20 kHz. Although not shown in FIG. 11, in embodiments, sound generator may include components such as tube 104 to direct airflow from blower 1106 through spin-air speaker 1106.

In FIG. 11, a rotational mean 1124 signal may be fed back to a clock (sync) module 1132 as clock input to logic module 1102. The signal from clock module 1132 may by used to confirm that plate 1114a is spinning at a target signal, e.g., such as a target signal intended to cause speaker 1101 to generate a sound frequency, such as a frequency indicated by any of waveforms 1126a . . . 1126c. Waveforms 1128a . . . 1128c indicate waveforms that may be composed of component waveforms 1126a . . . 1126c.

In an embodiment, such as sound generator 1000 or 1100, using a Python program, the sound generator may be made to create musical notes and play familiar songs and melodies. It was noted that an audible sound, perhaps a carrier signal, was always present when different notes were being played and between notes. To eliminate the unwanted sound, the rotational speed of the rotating disc may be slowed down to cause the sound frequency to drop below the audible range, i.e., cause a “quiet” note. This both eliminates the unwanted audible sound and also allows the spinning plate to be kept moving, which improves the response time from no sound to sound without demanding a high level of torque from the motor. As a result, the power of the motor may be reduced.

FIG. 12A and FIG. 12B include a schematic and images illustrating aspects of an embodiment of a spin-air speaker, e.g., spin-air speaker 900. An airflow 1204 indicates a forward airflow through spin-air speaker 900 and an airflow 1202 represents a reverse airflow. Images 1206a . . . 1206c represent the development of a forward airflow 1204a past a first plate represented by a solid element 1214 and through an opening 1220a through a second plate represented by solid elements 1212a, 1212b at an initial time (1206a), an intermediate time (1206b), and a final time (1206c). Downstream flows 1216a, 1216b, 1216c illustrate the downstream flow at the time. A hypothetical reverse flow 1202a is illustrated. In FIG. 12A, reverse curls 1218 are shown to develop with time. Enhanced suction from reverse airflow 1202b allows for forward airflow 1204a to flow more freely outward as 1210a transitions from 1208a,b,c,d. 1210 a, b, c are individual pulses moving forward. As they move forward circular pockets of air (1218) are shown disrupting the initial clean pulse pattern 1210a. The idea behind the double chop was to create some sort of back flow on the outside ring and suck circular pockets of air (1218) with a reverse air flow chop. The pulses in then out are sequential of one another and not at the same time. About the time the 1210a pulse makes it to the 1208b position there would be an inward pulse created in the positions of 1202b and sucking out circular air pockets (1218). In FIG. 12B, images 1208a . . . 1208d represent the development of a forward airflow 1204a through an opening 1220b at an initial time of ½ second (1208a), a first intermediate time of 1 second (1208b), a second intermediate time of 2 seconds (1208c), and a final time of 3 seconds (1208d). Downstream flows 1216a, 1216b, 1216c illustrate the downstream flow at the time. In FIG. 12, pulses (referenced earlier as “puffs”) 1210a, 1210b, 1210c are shown to develop with time and travel downstream. Each subsequent pulse adds forward impetus to the preceding pulse. Reverse curls appear to diminish the impetus added.

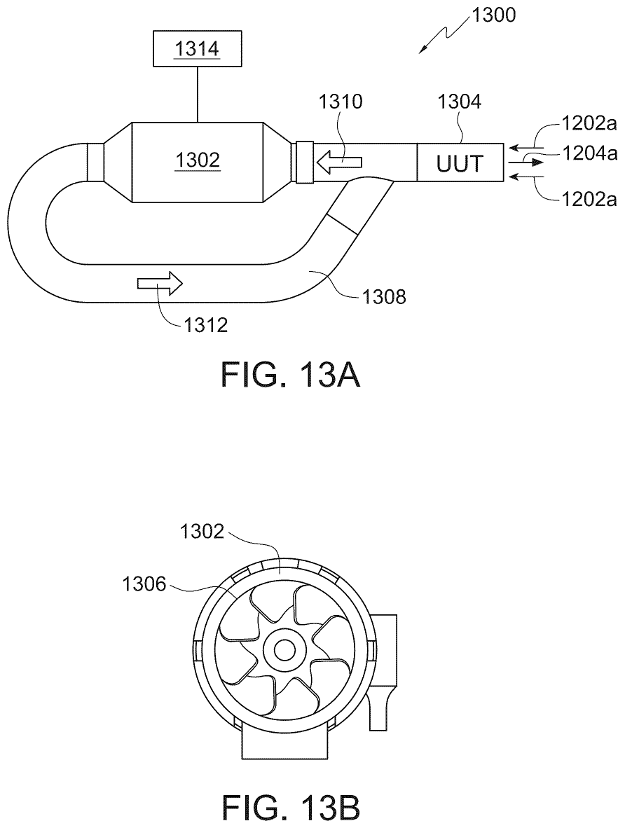

FIG. 13A is a side view illustrating an air flow generating system 1300 for producing flows 1204, 1202 of FIG. 12A. In FIG. 13A, system 1300 includes: a housing 1302 housing a blower 1306 (FIG. 13B); a tube 1304; and tube 1308; and a controller 1314. Blower 1306 causes flows 1310 and 1312, which in turn causes flows 1202a, 1204a into and from spin-air speaker 1304.

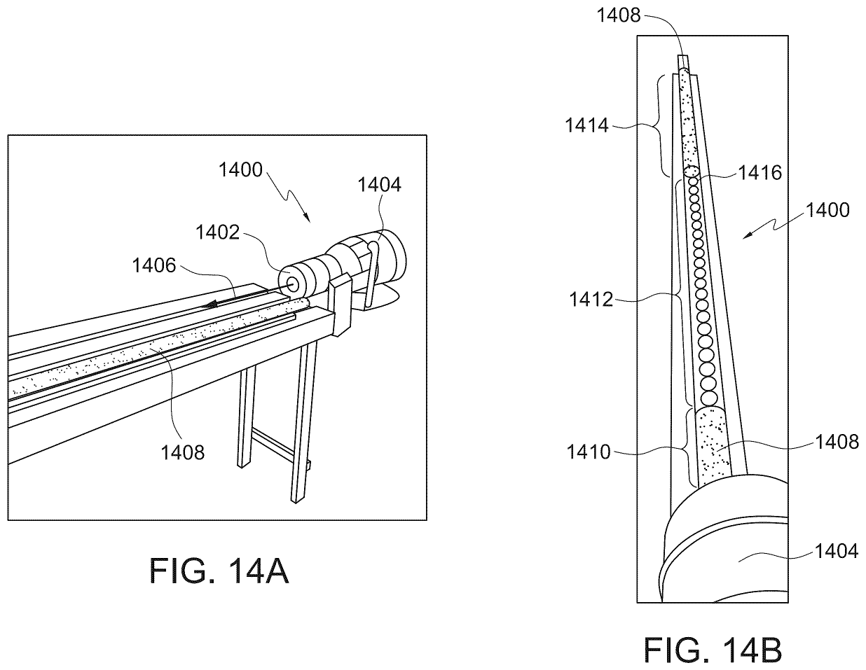

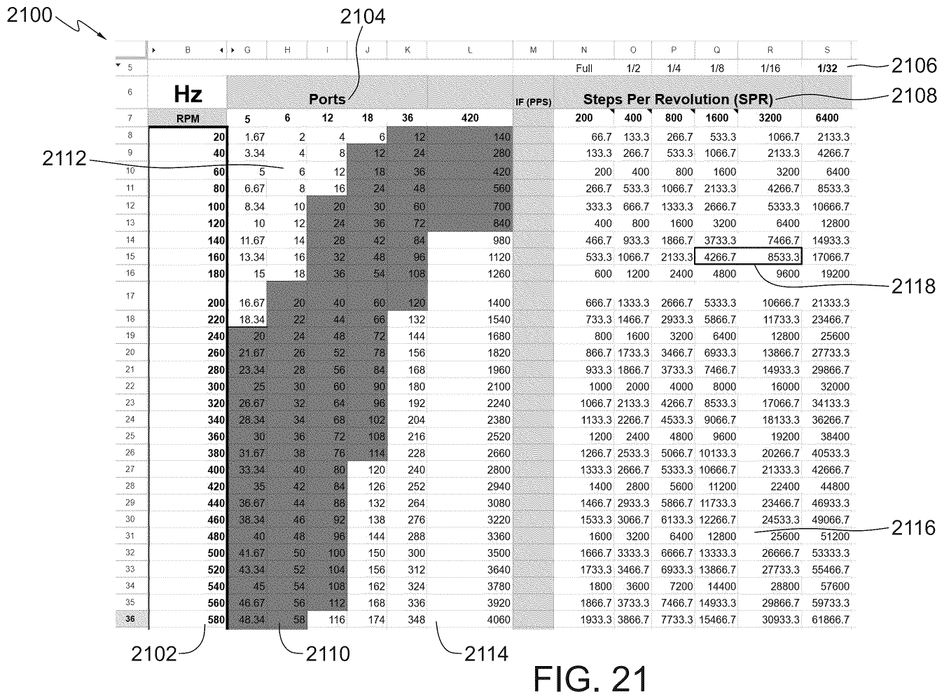

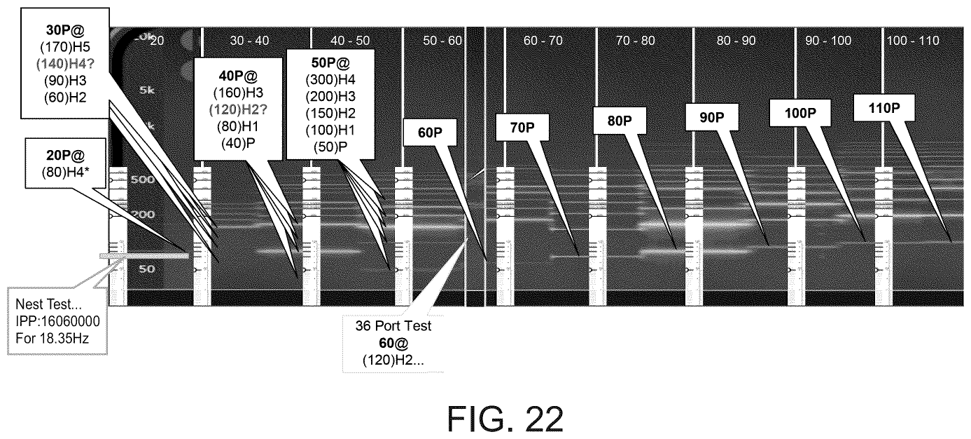

FIG. 14A and FIG. 14B are views of an embodiment of a spin-air speaker incorporated into a system 1400 for extinguishing fire created by sterno cans. System 1400 includes a spin-air speaker including a plate 1402 with a pattern of openings. A plate on the obscured side of plate 1402 includes a pattern of openings and is driven by a motor, as described earlier with regard to spin-air speakers. A blower 1404 provides an airflow 1406 that is directed through the spin-air speaker over a tray 1408 filled with a series of sterno fuel. In FIG. 14B, section 1410 of tray 1410 is empty and reserved for future testing, section 1412 is filled with sterno fuel 1416 (shown aflame); and section 1414 of tray 1408 is empty. The fuel tray for the sterno was a couple of wires about an inch apart with aluminum foil forming a small narrow trough to hold the fuel in a straight line. Regarding the tray 1408 and sterno flames, it was determined that the flames would exhibit a pattern, e.g., a standing wave pattern like that of the Rubens Flames experiment, similar to frequencies of Table 1. This simple tool allows the viewer to understand how fire reacts to different sound waves. This technique was used after the room was mapped out for visible reflections and natural harmonics generated in the room (See measurement details described with regard to FIG. 22). System 1400 provides an apparatus that allows the user to understand how fire reacts to different sound waves. This technique was used after the room was mapped out for visible reflections and natural harmonics generated in the room (See measurement details described with regard to FIG. 21).

TABLE 1
speculated sound frequencies (fundamental and harmonics) at
which flames will conform to the waveform of the frequency

| Fundamental | 1^{st} | 2^{nd} | 3^{rd} | 4rd | 5^{th} | 6^{th} |
|---|---|---|---|---|---|---|
| 18 Hz | 36 | 54 | 72 | 90 | 108 | 126 |
| | Hz | Hz | Hz | Hz | Hz | Hz |

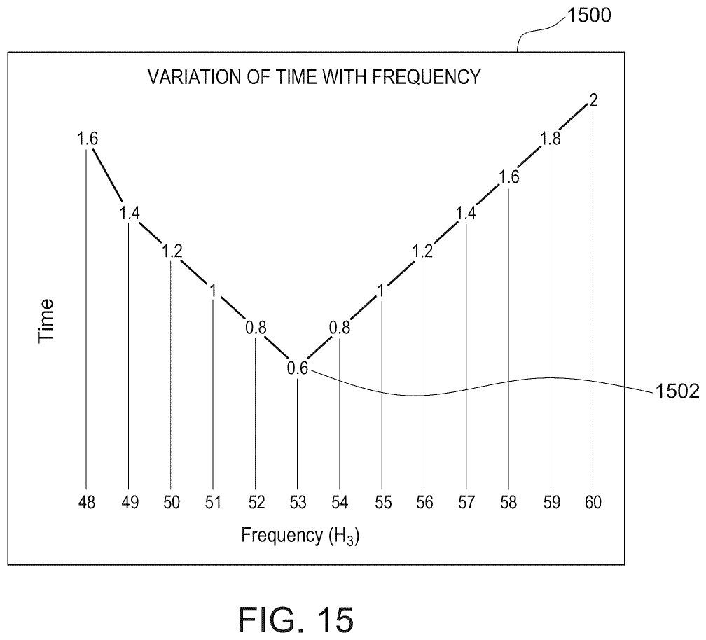

FIG. 15 is a chart 1500 illustrating results similar to the results produced by system 1400 of FIG. 14A and FIG. 14B. It was noted that the flame of sterno fuel 1416 increase with increased airflow and then began to match the pattern displayed in 1412. The minimum value of 0.63 seconds observed by 1500 represents the time required to extinguish fire from a prior art study. The optimal frequency found with system 1500 to extinguish fire was the sound frequency of 53 Hz. The optimal frequency found with system 1400 varied anywhere between 51-55 Hz depending on the technique used to extinguish the flame.

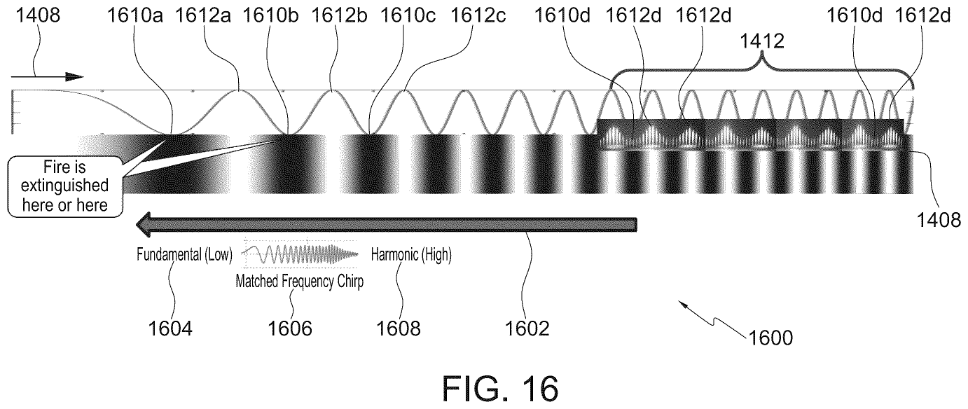

FIG. 16 is an illustration of aspects of the results produced by system 1400 of FIG. 14A and FIG. 14B. In FIG. 16, schematic 1600 illustrates tray 1408 from the side and imposes a waveform 1602 over it to illustrate the effect seen of sound from system 1400 on simulated flames of sterno cans 1412. Waveform 1602 includes an initial section that corresponds to tray section 1412. When sound of this frequency was maintained over tray section 1412, the flame assumed shapes corresponding to the wavelength of the standing wave with partially extinguished zones 1610d separated by non-extinguished zones 1612d. As the frequency was increased, e.g., from an initial high harmonic 1608 to a next lower harmonic, the lengths of the partially-extinguished zones 1610c and non-extinguished zones 1612c lengthened with the wavelength, and the level of extinguishing of the flame increased. Further lowering to a next fundamental led to increased lengthening of the associated partially-extinguished zones 1610b and non-extinguished zones 1610b and then partially-extinguished zones 1610a and non-extinguished zones 1610a. The end result of lowering the frequency was that, when the extinguished zone of the sound wave covered the lit sterno fuel, the flames were extinguished.

Instrumentation associated with system 1400 was not able to detect frequencies lower than 14 Hz, but the test flames were certainly reacting to those lower frequencies.

It was noted that fire could be extinguished using one of the harmonic frequencies coupled with enough power to the blower and a well-timed phase shift (same frequency as before and after the change) at the end of the pulse, i.e., at the low frequency end of chirp 1606.

In an embodiment, a flame may be extinguished by directing a sound from an embodiment of a system employing a spin-air speaker, e.g., systems 100, 700, 1400 at the flame, where the waveform of the sound is a descending chirp that begins at an initially high frequency and, with time, is modulated to drop through a series of frequencies to a low frequency in which the waveform is sufficiently long so that the trough—the extinguishing zone—is extensive and, as a result, the flame is extinguished.

In an embodiment, the extinguishing may be determined by first determining harmonics of frequencies that, when directed at the flame, cause the flame to assume a shape associated with the length of the waveform of the harmonic. In this embodiment, the descending chirp begins with an initially high harmonic and cycles down through the harmonics to a low or lowest harmonic, i.e., the fundamental frequency.

The phenomenon illustrates by FIG. 16 may be described as follows: in section 1412 the frequency of the sound was influencing the ability of the fire to burn the fuel of the sterno cans. In the following, the phrase “fundamental frequency of fire” refers to the lowest frequency of sound that causes the fire to exhibit a standing wave pattern corresponding to the wavelength of the frequency. Similarly, the phrase “harmonic frequency of fire” refers to a multiple of the lowest frequency of sound that causes the fire to exhibit a standing wave pattern corresponding to the wavelength of the frequency. Each “harmonic frequency of fire” was also found to cause the fire to exhibit a standing wave pattern corresponding to the wavelength of the frequency.

The observation of the sterno flames conforming to the waveform of the sound led to the coining of a term “pyrosonic” to describe the influencing of fire by sound. Pyrosonic: a fusion of the terms “pyro” (relating to fire) and “sonic” (relating to sound), suggesting a meeting point between the two. The standing waves of the flames show a point where sound and fire physically move as one. A pyrosonic “lock” occurs when the flame conforms to the waveform of the frequency produced by the system. This phenomenon was achieved and observed by igniting sterno fuel in line with the output of system 1400, a low-frequency sound source, and then adjusting the output frequency by modulating the speed of the motor driving the spin-air speaker until the sterno flames exhibited a pattern similar to that of section 1412 of FIG. 16. Sterno provided a suitable test flame because airflow increases the flame, yet the flame is delicate enough that it responds quickly when a pyrosonic lock occurs.

Once the approximate fundamental frequency is known, targeting one of the harmonic frequencies was a faster approach to achieving a pyrosonic lock. A pyrosonic lock was detected by observing the flames—a lock appears much like the pattern exhibited by the Rubens tube experiment without the tube. A pyrosonic lock may be achieved by causing the spin-air speaker to create a known frequency and adjust that frequency until a standing wave pattern is observed in the fire. In an embodiment, the longest standing wave that the flame exhibits while in “pyrosonic lock” may be considered to be the fundamental frequency of the fire. Obtaining a pyrosonic lock on one of the higher harmonics may be easier to do than going after the lower ones or the actual fundamental frequency. Obtaining and then maintaining a pyrosonic lock with harmonic frequencies was more forgiving and actually can shift the fundamental frequency up or down depending on the environment.

Locating one of the harmonic frequencies of fire depended on the fundamental frequency of the fire. The fundamental frequency of fire, in turn, depends on the environment in which it is burning. FIG. 15 was used as an approximate starting point. System 1400 produced considerably different values. For example, the actual fundamental frequency produced by system 1400 was about 4 Hz off of the speculated frequency, i.e., for system 1400 the fundamental frequency of the fire was found to be approximately 14 Hz instead of 18 Hz.

The room in which system 1400 was set up was found to resonate at approximately 42 Hz. Tests conducted in the room seemed to result in higher fundamental frequencies of fire higher in comparison to tests conducted outside. The key to controlling fire was locating the fundamental frequency and then creating a “Pyrosonic” lock to a frequency near the corresponding harmonics of that particular fire. A challenge was isolating the harmonics and reflections generated by the test environment before focusing on the fundamental and harmonic frequencies of the fire.

In an embodiment, a method for locating the frequencies of sound that cause a fire to assume a standing wave pattern (e.g., locating the harmonic frequencies of fire) includes the following steps, using, e.g., spin-air speaker 101 and with plates 114a, 114b provided each with 18 openings that are in-line with one another (e.g., as depicted by openings 818 of FIG. 8F) such that, when one of the disc spins all the holes are either open or closed at the same time.
1. Select a stepper motor and controller combination that can handle at least 200 RPM which is roughly 4266 Pulses Per Second @⅛ steps.
1. Calculate the microsteps for controlling the stepper motor (e.g., using the Python code below)
2. Attach the spin air speaker to an air supply tube
3. Once the air is moving through the device, spin it up and down using the controller and observe the different sounds that it makes.
4. Download an application for your smartphone and map out the different frequencies you can generate with this configuration.
5. Start the disc spinning and allow it to stabilize somewhere around 75 Hz.
6. Measure and map out the frequency generated using the Spectrograph lava display using the logarithmic scale.
7. Make sure your device can cleanly generate your desired frequency and the related harmonic frequencies. Sometimes the construction of the device can generate or develop unwanted frequency variations.
8. Repeat this process all the way down to 20 Hz (or lower) and observe the related harmonic frequencies.
9. At this point, the apparatus has the ability to create and detect frequencies below what most instruments can measure and what humans can hear.
10. Stop the air and the device
11. Build a fuel tray for Sterno using a couple of wires about an inch apart with aluminum foil forming a small narrow trough to hold fuel in a straight line.
12. Fill it with Sterno Fuel and light it on fire
13. Dim the lights to get a better view of the flame within the trough
14. Start the air flow again with wide open ports
15. Notice how the flame increases with air when the air flow starts
16. Stabilize the sound frequency again somewhere around 75 Hz
17. Start to incrementally decrease the number of micropulses until an on/off flame pattern begins to form such as that shown in section 1412 of FIG. 16. This pattern forms fairly close to the output of the device with higher frequencies.
18. Once the pattern is achieved at a particular frequency, move down about 10 Hz and incrementally increase the number of micropulses until an on/off flame pattern begins to form again. It may be that the frequency might be higher than what was measured the first time.
19. Repeat this high/low incremental approach until a consistent frequency pattern can be found. For example, if 72 Hz was the number discovered in the previous step. Half of 72 is 36. Now repeat the high/low incremental approach until a consistent frequency pattern can be found around 36 Hz. The challenge at this point is that it may be closer to 36.75 Hz or so. At this point perhaps double the frequency (36.75×2) and confirm the previous value still works at 73.5 Hz. When a pyrosonic lock is achieved, changing the frequency of sound can result in the flames following the changing shape of the waveform—in this sense the fundamental frequency of fire or the harmonic may appear to be moved up or down. It may be helpful to sneak up on the frequency pattern before the fire has time to adjust to the frequency and form a pyrosonic locking pattern. A pyrosonic lock is close when the fire begins to cycle back and forth with multiple sinewaves like an older analog type tuner TV. But, when the sound frequency is left too long on a frequency just before the target harmonic frequency, the fire will conform to the sound frequency—providing a false positive of the harmonic frequency.

Now it is possible to simulate a descending chirp signal as closely as possible to match the observed harmonic frequencies by performing the following steps.
1. Build a program that allows you to switch between the observed pyrosonic frequencies, preferably switching quickly. Use the corresponding micro pulse patterns with each step. For each harmonic, the micropulses used to drive the frequency at that harmonic may be associated with a specific key or step such that switching between pyrosonic frequencies is achieved by driving speaker 101 at predetermined micropulses. A keypad may be used to switch between target micropulse values in conjunction with visual observations.
2. Practice fine tuning the micropulses associated with each step such that each step achieves a pyrosonic lock until the system can be made to move easily between pyrosonic locks at each harmonic frequency down to the lowest possible frequency that achieves a pyrosonic lock. This lowest frequency is preferably a very large sign wave pattern with a very large extinguishing zone. In an embodiment, an acceptable lowest frequency may be one in which more than half of a 6 meter test bed of sterno flames is extinguished. Once that is achieved, the micropulses may be adjusted up or down to cause the extinguished section of the sterno flames to move forward and backward. This will indicate where the edge of the extinguishing zone is.
3. It is now possible to create a manual descending frequency shift by lowering the micro pulses quickly until the flame goes completely out, perhaps up to 6 meters away.
4. Map out which frequencies work on a consistent basis. Note: The mapped out frequencies for this specific fuel and environment may change if either are modified.

In an embodiment, each extinguishing zone may be the result of exhaust gasses from the fuel being pushed back down or held down upon the fire itself such that the fire is smothered. It is surmised that the strength of the sound wave moving through the air must be to extinguish the fire depends on the rate at which the fire is consuming oxygen—a relatively stronger sound wave is necessary to extinguish a fire that is rapidly consuming oxygen and vice versa. For example, temperatures from grass fires in open fields range 400 to 800°. The harmonics produced from this source of fuel would be very different from a grease or brush fire. These fires would generate a completely different set of frequency patterns as part of their exhaust gasses. A question to consider when regarding a fire is: how much energy in a sound wave and of what frequency should the sound wave be to overcome the harmonics of the fire's exhaust gasses?

In an embodiment, what is meant by “control over a harmonic” may mean that a frequency has been created by the system that causes the fire, e.g., sterno flames, to exhibit a clear standing wave pattern like that of section 1412 of FIG. 16. With the text illustrated by FIG. 14, the lowest frequency at which pyrosonic lock was achieved had a wavelength of over 24.5 m. Thus, the extinguishing portion was approximately 12 m long.

In an embodiment, when the flames are relatively near the spin-air speaker, e.g., 1-2 m away, the system may not require lower harmonics, such as the 1^{st} harmonic, to extinguish the fire. In such a case, higher harmonics, such as 2^{nd} or 3^{rd} harmonics may be sufficient to extinguish the fire. The standing wave just needs to be long enough for the phase shift to walk the fire away from the source of fuel

Since the focus was locating the point at which the standing wave is forming (or beginning to form) is in front of or behind the fire, and whether it is moving toward or away from the fire, it was very important to locate precisely where that point was within 6 meters at around 14 Hz. If that point was too early, the whole trough would light up and you would lose lock. If it was too late, the whole trough would light up and you would lose lock. If you managed to locate it somewhere within the 6 meters, half the trough would be lit up and you could move it back and forth with the S/W. As long as I could see a blank spot of fire somewhere in the beginning of the trough, I was still in pyrosonic lock. For example, if a standing wave was visibly influencing the fire closest to the UUT (or in front) it is considered to be in pyrosonic lock. If the standing wave is assumed to be behind the test fire trough (behind the fire) it is not considered to be in pyrosonic lock. In such a case, after a few seconds, return to one of the known harmonic frequencies and adjust either up or down. It is easier to grab a third or second harmonic than the lowest fundamental frequency.

FIG. 17 is a schematic illustrating a use case 1700 for system 100 of FIG. 1 and illustrating aspects of sounds produced by the embodiment. In FIG. 17, a target fire 1702 is extinguished by a user 1712 using sound generating fire extinguishing system 100 by generating a series of sound pulses 1706c, then 1706b, then 1706a. Each pulse, e.g., 1706a may be defined by a frequency shift 1704, a pulse width 1714, and a pulse reproduction interval 1716. Pulse reproduction interval 1716 represents a time between each initiation of a pulse. Pulse width 1714 represents the duration of a pulse, e.g., pulse 1706a. Frequency shift 1704 represents a rate of change of frequency such that, starting from an initial high sound frequency, the rate of change of the frequency results in the sound changing from a predetermined high frequency sound to a predetermined low-frequency sound within the duration of pulse width 1714. A distance 1710 represents a distance from the spin-air speaker of system 100 to the reflective surface of user 1712. In an embodiment, pulses 1706a . . . 1706c may be descending chirps of approximately 0.3 s pulse width in duration. In an embodiment, pulse repetition interval 1716 influences the length and efficiency of the vortex tube. A vortex pulse wave and standing sound wave are generated by two completely different methods and traveling in two completely different medians. Where those two pulsing cycles can efficiently meet somewhere in front the opening and combine their forces of fire extinguishing power is based on empirical data. My goal was to reach 6 M or 20′ to extinguish a flame. Once the optimal frequency pattern for the pyrosonic lock is known, we should be able to adjust the length of the vortex tube to assist with fire extinguishing capabilities within 2-3 M away

In an embodiment, a method for extinguishing a fire is, using a spin-air speaker, to direct a series of descending chirps at a flame. One or more of the frequencies within each chirp causes at least one “trough” in the fire (an extinguished point) and as the chirp passes through the fire, the extinguished trough, or troughs, travel through the fire causing the fire that is covered by the trough to be extinguished. In an embodiment, the frequency created by the spin-air speaker is low such that the wavelength of the frequency creates an extinguishing zone that covers and extinguishes a section or all of a fire. In such an embodiment, the extinguishing zone—half of a standing sine wave—would remain in place over a fire and extinguish the file.

In an embodiment, if pyrosonic lock is maintained and the system quickly switches between creating the third, second, and first harmonics, a visual queue is the base of the sine wave—the extinguished zone—growing from covering a ¼ a meter closest to covering the entire length of 6 meters. In such a situation, if the 1^{st} harmonic standing wave were caused to move forward or backward, then pyrosonic lock would be lost, e.g., like zooming in with a telescope on an object and losing the object within your field of view along the way.

In an embodiment, a goal of motor control is to control the frequencies produced by the spin-air speaker so that they do not stray from a target frequency determined to cause pyrosonic lock. When motor control is too coarse to maintain a desired rotational rate of the spin-air speaker it is difficult to maintain pyrosonic lock. A pyrosonic lock may shift the fundamental frequency and all of the harmonics related to it for fire while the pyrosonic lock is being manipulated up or down.

Regarding locating the most efficient use of the pyrosonic lock phenomena. Efficiency is improved when specific incremental steps are taken between the harmonic frequencies of fire down to the fundamental frequency to maintain lock or control over it. Pyrosonic lock may be lost when the change in frequency gets out of step with the merging of harmonics moving towards the fundamental frequency, much like missing the correct increasing rhythmic pulse when pushing a child on a swing. One bad offbeat could destroy the swinging motion and sometimes it is easier to start over.

The terms “frequency synchronization” or “phase synchronization,” are related to the concept of pyrosonic locking. These phenomena occur when an external signal of a similar frequency influences another oscillator, causing the second oscillator's frequency (or phase) to align or “lock” to the frequency of the external source.

In injection locking, a small signal at or near the natural frequency of an oscillator is injected, and the oscillator's frequency becomes entrained to the frequency of this external signal. This leads to a situation where both frequencies synchronize, and the oscillators operate in unison. This concept is widely used in various applications, including lasers, electronic oscillators, and even biological systems.

There is a theoretical limit as to how fast one can move away from the active frequency once “frequency synchronization” or “phase synchronization” is achieved and still maintain lock. It can be described as being based on the following key factors influencing this rate.

Locking Bandwidth: The range of frequencies over which the oscillator can lock to an external signal. A wider locking bandwidth allows for greater frequency deviation while maintaining synchronization. In some embodiments, a spin-air speaker has the necessary bandwidth to follow the harmonic locking frequencies down to the fundamental frequency of fire.

Quality Factor (Q) of the Oscillator: Oscillators with a high Q factor have a narrow bandwidth and are more selective in frequency, which means they might lose lock more easily when the frequency starts to deviate. Preventing unwanted deviation of sound frequency drives the selection of, e.g.: a motor (requires sufficient torque); a controller; and the construction of the spin-air speaker.

Strength of Coupling: The stronger the interaction between the primary signal and the oscillator, the more robust the lock. Stronger coupling can potentially allow for a faster rate of frequency change while maintaining synchronization. This becomes a factor of volume with the spin-air speaker and volume is increased with airflow.

System Inertia: In some systems, especially mechanical or biological oscillators, inertia can play a role in how quickly the system can respond to changes. This is primarily influenced as part of the feedback loop from the reaction of fire per the injection frequencies. In tests of embodiments, the test flame patterns sometimes resembled horizontal hold patterns that were prevalent with older analog-type TV tuners. This would happen when the sound frequency was starting to walk into or out of a harmonic frequency. There would be multiple interlinking sine wave patterns displayed within the flame. Pyrosonic lock would be lost when the sound frequency was moved too far off the visually apparent harmonic frequencies. When the volume is high enough under a pyrosonic lock and a phase shift large enough to move the bottom of the fundamental/harmonic sine wave away from the fuel source, the fire would go out. The reverse was also true for reigniting the fire. A phase shift large enough to move the top of the fundamental/harmonic sine wave toward the fuel source, the fire would reignite. The controlled visual flame observations to software reactionary procedures were proven to be an effective method for extinguishing flames, as described in [00096] and [00097].

Nonlinear Dynamics: In certain complex systems, nonlinear effects can either enhance or limit the rate at which frequencies can diverge while maintaining synchronization. The enhancement derived from pyrosonic locking is to follow the harmonics as closely as possible down to the fundamental frequency of fire and then phase shift it out of existence. The alternative to this is to “Increase the Strength of Coupling” via the volume and overpower the harmonic or fundamental frequencies.

In an embodiment, the motivation was to extinguish flame up to 20′/6 meters away. This size of the motor can be reduced when staying on and hopping between harmonic frequencies. It is possible to ignore the harmonic frequencies altogether and increase the volume using the phase-shifting extinguishing pattern to compensate. However, the effective range of this technique is greatly reduced.

Embodiments for influencing and controlling fire provide a number of possibilities. In some embodiments, the optimal sound pulse to extinguish the fire is a descending chirp with matched harmonic filtering, i.e., a chirp with frequencies determined by determining the fundamental frequency of a fire and the harmonics associated with that fundamental. There is no ascending chirp part in this signal. In an embodiment, the time and amplitude between these generated pulses may be based on an environmentally determined and industry-induced acceptable reaction.

In an embodiment, a chirp signal may be a combination of frequencies merged as one starting from high and then going to low and then back again to high. This signal is commonly used in the industry for radar. The merged harmonic filtering part of this signal is needed to keep the nonlinear dynamics part of this equation as optimal as possible.

The laws of reflection hold to a particular frequency of sound when the wavelength of that frequency is smaller than the dimensions of the reflecting surface. The maximum amount of force needed to reflect a sound wave can be measured @ % wavelength. Example: 30 Hz has a wavelength of 37.5 feet which would require a minimum of 9.38 feet thickness to obtain 100% reflection.

The Hz formula also works when the air is flowing alternately in the reverse direction via the vacuum flow and forward direction with pressurized airflow. The main difference in this approach is that the rotating plate of an embodiment of a spin-air speaker 900 doubles up the frequency per rotation.

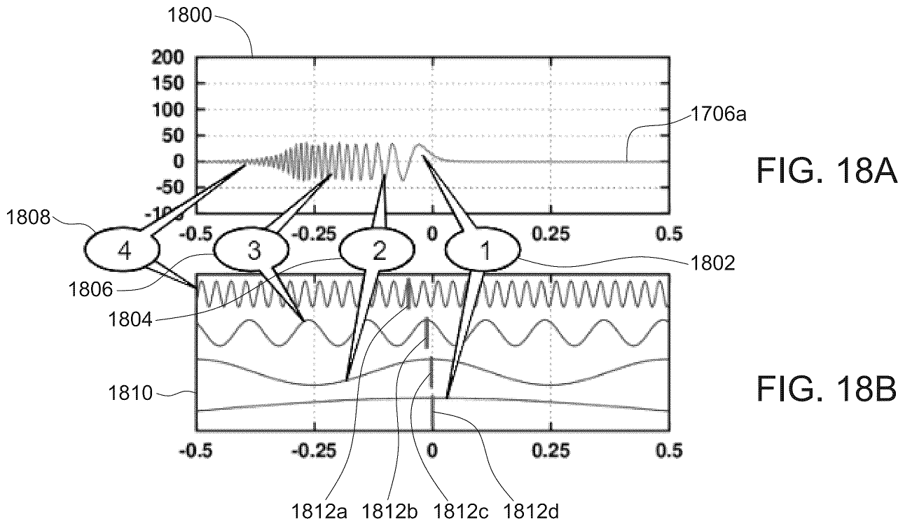

FIG. 18A and FIG. 18B are spectra illustrating aspects of a pulse, e.g., pulse 1706a of FIG. 17. A spectrum 1800 shows pulse 1706a having matched harmonic filtering changing with a duration of approximately 0.3 seconds from an initially high harmonic 1808, to a lower harmonic 1806, to a lower harmonic 1804, to the fundamental frequency 1802. Frequencies 1802 . . . 1808 may include a fundamental frequency and harmonic frequencies 1, 2, and 3, which may have been determined to achieve pyrosonic resonance (pyrosonic lock) by observation and/or calculation. Frequencies 1808 . . . 1802 are illustrative and not all-inclusive. The chirp of FIG. 8A is a signal in which the sound frequency decreases with time—a descending chirp. The term “chirp” signal has been used “sweep” signal. In FIG. 18B, each frequency indicated in FIG. 18A is shown in steady state. The relative positions of lines 1812a . . . 1812d indicate the relative phase shifts between the frequencies.

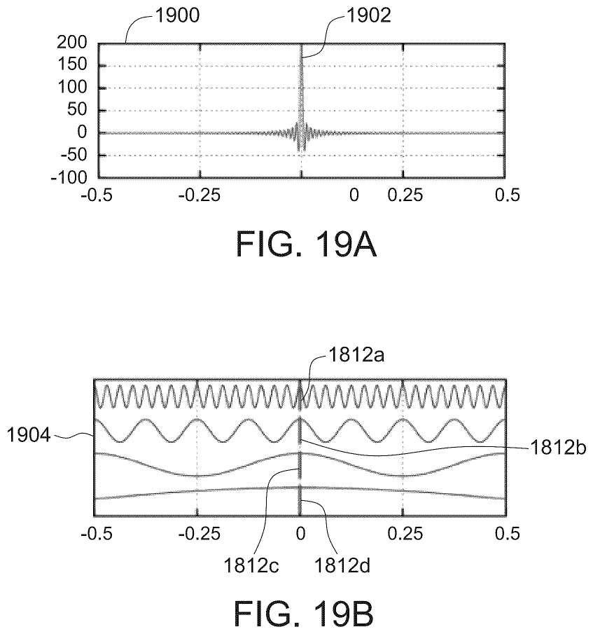

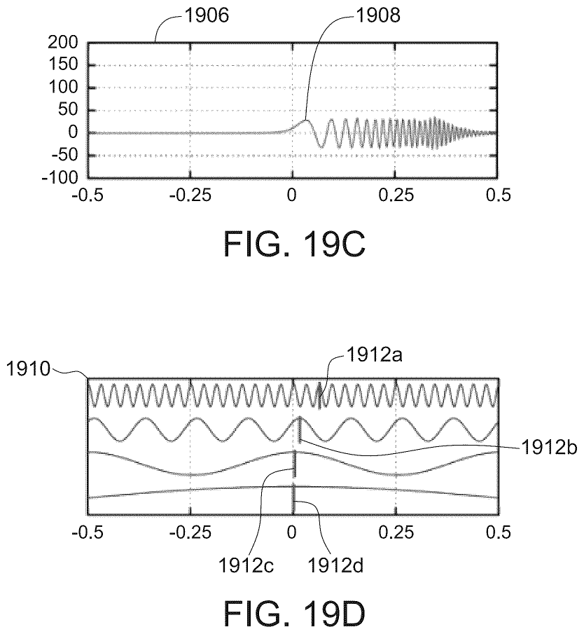

FIG. 19A-FIG. 19D are spectra illustrating aspects of sounds produced by an embodiment of a system for extinguishing fire. FIG. 19A-FIG. 19D illustrates other signals that may be produced by embodiments of a spin-air speaker and that may be used for extinguishing fire. In spectrum 1900, an impulse 1902 is shown. Spectrum 1904 illustrates that impulse 1902 is composed of frequencies, e.g., frequencies 1812a . . . 1812d, with no phase shift between them. Spectrum 1906 of FIG. 19C illustrates an ascending chirp 1908 beginning with a low fundamental frequency 1912d (FIG. 19D) and increasing through harmonics 1812c, 1812b, to harmonic 1812a (FIG. 19B), with the phase differences illustrated by lines 1912a . . . 1912d (FIG. 19D). In embodiments, sounds used to extinguish fire may use an ascending chirp, a descending chirp, or a combination. In embodiments, sounds used to extinguish fire may use one or more of a fundamental frequency as discussed earlier or any of the harmonics of that fundamental. In embodiments, sounds used to extinguish fire may be chosen arbitrarily.

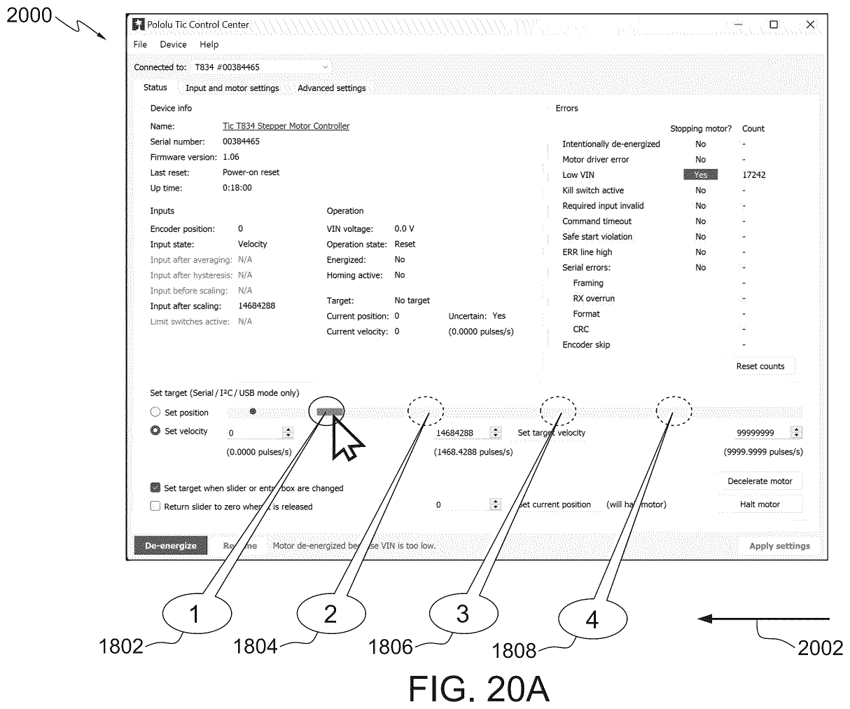

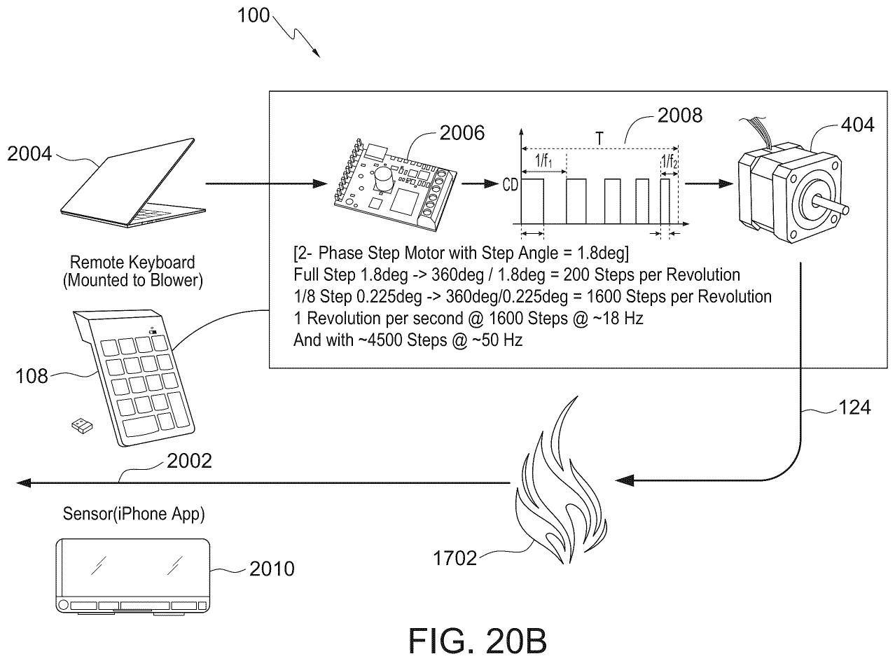

FIG. 20A is a screenshot 2000 from an embodiment of a system for extinguishing fire. FIG. 20B is a schematic of the embodiment of the system for extinguishing fire of FIG. 20A. In FIG. 20A, screenshot 2000 illustrates that frequencies 1802 . . . 1808 (FIG. 18B) may be cycled through in a controller using a slider that may be moved laterally between frequencies or by having buttons associated with each target frequency. A signal 2002 (SW Visual feedback in conjunction with the fire movements in response to the keys being pressed) may be received from a sensor, e.g., a sensor on a smart phone 2010, such as an iPhone®. Frequencies 1802, 1804, 1806, and 1808 represent four potential positions the slide bar could move to upon pressing a key on the keypad. The last key pressed was the phase shift which may not be visible when it moves. In FIG. 20B, system 100 is shown to include a stepper motor driver 2006, which may be programmed by a computing system 2004 to have a drive profile 2008 for controlling motor 404. Drive profile 2008 may subsequently be called by controller 108 to cause motor 104 to produce sounds 124 that are directed at fire 1702 to extinguish it. In an embodiment, stepper motor 404 is a 2-phase step motor with step angle of 1.8 degrees. In such a motor, a full step of 1.8 deg results in: (360 deg/1.8 deg) 200 steps per revolution. One hole on a spinning plate, spinning at 60 RPM (1 rev/sec) gives you 1 Hz. Two evenly spaced holes, same speed gives you 2 Hz. 18 evenly spaced holes, same speed, 18 Hz. Full rotation Steps for most common stepper motors are (200, 400, 800, 1600, 3200, 6400) for (Full, ½, ¼, ⅛, 1/16, 1/32). The greater the number of steps you have available per revolution, the more torque you have available per degree of movement. I was toggling somewhere between ¼(800) and ⅛(1600) step with the stepper motor I was using when attempting to maintain Pyrosonic Lock down to the fundamental frequency. The bigger the motor the more torque you have available per step. The one I was using was rated at 2.2 lbs. of holding force per step. We could use (200, 400, 800, 1600, 3200, 6400) for (Full, ½, ¼, ⅛, 1/16, 1/32) @ 60 RPM to achieve 18 Hz with 18 evenly spaced Holes. As part of the calibration process I increased/decreased the number of “micro” steps per rotation based on the feedback I was getting from my tachometer. Example: 800/rev could have been bumped to 805 to achieve a particular RPM, measured frequency, or visual observation as noted within the fire itself.

Using this configuration of FIG. 20A and FIG. 20B, four separated pulse patterns were calculated, observed, and then manually implemented using visual cues observed from the fire while maintaining a pyrosonic lock. The remote keyboard 108 was used to trigger the system to switch between the four pulse patterns 1802 . . . 1808 and then phase shift fire 1702 to extinguishment. Fire 1702 extinguished with a phase shift near one of the harmonic frequencies. Fire 1702 was extinguished using descending chirp with filtered matched harmonic frequencies blended in pattern near the fundamental frequency up to 20′/6 meters away.

FIG. 21 is a screenshot 2100 showing test results from an embodiment of a system for producing sounds. In FIG. 21, the combination of a plate RPM 2102 (along the side) and a number of ports 2104 (along the top) produced the frequencies shown at the intersections of the respective column and row. The fidelity of 2102 is user adjustable for this worksheet. 2100 was used as a starting point for the RPM and stepper motor calibrations which were stored in rows and columns to the right off screen as well as comments and cell formatting. Row 2106 indicates a portion of a rotation of a stepper motor. Row 2108 indicates the number of steps the stepper motor needed to sweep through to achieve the rotation of row 2106. Section 2110 indicates desired target frequencies within the known range of extinguishing flames. 2112 and 2114 are outside the areas of interest for generating frequencies for extinguishing fire. Section 2116 is the calculations RPM 2102 X Steps per Revolution 2108 with the same Port Configuration 2104 calculation as 2110.

FIG. 22 is a composite image of a calibration of an embodiment of a system for producing sounds. In FIG. 22 the system being calibrated included 18 ports in the spin-air speaker spinning plate. The microphone was positioned at 5 m from the spin-air speaker and an AC Infinity, 10-speed fan controller, Duct Size: 8″, Airflow 724 CFM was set at 50% power (362 CFM). The frequencies across the top indicate a frequency target range using the RPMs from the “18 port” column of FIG. 21. The scale of the readings was logarithmic. The images shows a composite of nine different tests at the following ranges: 20, 20-30, 40-50, 50-60, 60-70, 70-80, 80-90, 90-100, 100-110 Hz range. FIG. 22 represents the calibration of a dome-shaped spin-air speaker system from 110 Hz down to 20 Hz. The measurement device was sensitive down to 30 Hz. The results indicate the second, third, and fourth harmonics (H2, H3, and H4) as it was performing below the instruments measuring capabilities—H1 sometimes being below detection. Generating frequencies this low using cone-style speakers typically requires enclosures larger than a 10′×10′ room.

This measurement is known as a Spectrograph lava display using the logarithmic scale. This test was performed many times with different test units and physical configurations. This type of test and measurement was repeated for each test configuration to characterize their performances. The application provided a simple scale on the left which can be partially seen as 5k, 1k, 500, 200, 50 Hz. The bottom line represents 30 Hz. These images were serially stitched together after each test making sure frequencies lined up between tests. After that, a scaled logarithmic ruler was lined up and resized to fit this scale then repeatedly displayed in white next to each test. The small ½ bubbles on the side of the logarithmic scale line up with the application frequencies of 500, 200, and 50 Hz.

This test measurement shows the fundamental frequency (y-axis) as well as the harmonics over time (x-axis) with each test sound. The letter “P” represents the Primary Frequency (fundamental frequency) and “H” for the different Harmonic levels. The brightness illustrates the intensity of the measured signal. The 80P and 90P tests demonstrated that the integrity of this test spin-air speaker was failing near those frequencies due to the blurred frequency measurements. It was right around the 80 Hz mark, a close multiple of 42 Hz, where this spin-air speaker model failed. This lab resonated and reflected many waves in multiples of 42 Hz. Other intensified lines observed were traced down the naturally generated harmonics or surface reflections within the lab or the device itself. Environmentally generated harmonics were isolated by moving the Unit Under Test (UUT) to different positions within the lab or testing outdoors. Very similar to what you hear in a tile shower when humming and moving around. For example, the walls of the lab were more than thick enough to reflect the lowest primary frequencies my instruments could measure which was 30 Hz.

Embodiments of spin-air speakers may be used to create sound for: siren-converted public address/entertainment systems; high wind warning systems; soft breeze-driven music or musical notes; integrated HVAC public address systems; outdoor fan-driven public address/entertainment system; and wind/air-driven noise canceling technology; among the many systems that would benefit from using sound generated using spin-air speakers.

Embodiments of spin-air speakers may be used in systems for extinguishing fire with air and sound. Examples of such systems include: leaf blower-based adaptor kits for adding spin-air speakers extinguishing grass fires; kits for adding spin-air speakers to lawn and industrial blowers for extinguishing fires; kits for adding spin-air speakers to hand-held jetpack for extinguishing fires; kits for adding spin-air speakers to kitchen fire suppression protection, lab/server equipment fire protection, and cockpit/capsule fire protection systems for extinguishing fires.

The formulas for determining frequency based on plate/opening configurations work regardless of the direction of the flow of air. In an embodiment, a frequency of sound generated by a spin-air speaker may be calculated as follows: Hz=(RPM×Ports)/60. In an embodiment, a number of stepper pulses per second (PPS) needed to achieve a target RPM may be determined as follows: PPS=(RPM×Full Steps Per Motor Rotation×Microstep Ratio)/60. The “Microstep Ratio” is used as a variable soft switch to request calculations for either ¼, ⅛, or 1/16 for a stepper motor in combination with other provided variables.

In an embodiment, the following generic Python program illustrates how to convert RPMs, the number of <equally spaced> ports, and microstep modes to Hz and the required PPS needed to drive the stepper motor.

```
#include <stdio.h>
// Function to calculate Hz and PPS
void calculate_hz_and_pps(int rpm, int ports, char*
microstep_mode, double *hz, double *pps) {
  const int FULL_STEPS_PER_ROTATION = 200;
  int microstep_ratio;
  // Determine the microstep ratio based on the input mode
  if (strcmp(microstep_mode, “1/4”) == 0) {
    microstep_ratio = 4;
  } else if (strcmp(microstep_mode, “1/8”) == 0) {
    microstep_ratio = 8;
  } else if (strcmp(microstep_mode, “1/16”) == 0) {
    microstep_ratio = 16;
  } else {
    // Default to 1 if an unrecognized mode is provided
    microstep_ratio = 1;
  }
  // Calculate Hz and PPS
  *hz = (double)(rpm * ports) / 60.0;
  *pps = (double)(rpm * ports * FULL_STEPS_PER_ROTATION *
  microstep_ratio) / 60.0;
}
int main( ) {
  int rpm = 100; // Example RPM
  int ports = 18; // Example number of ports
  char microstep_mode[ ] = “1/8”; // Example microstep mode
  double hz, pps,
  calculate_hz_and_pps(rpm, ports, microstep_mode, &hz, &pps);
  printf(“Frequency (Hz): %.2f\n”, hz);
  printf(“Pulses Per Second (PPS): %.2f\n”, pps);
  return 0;
}
```

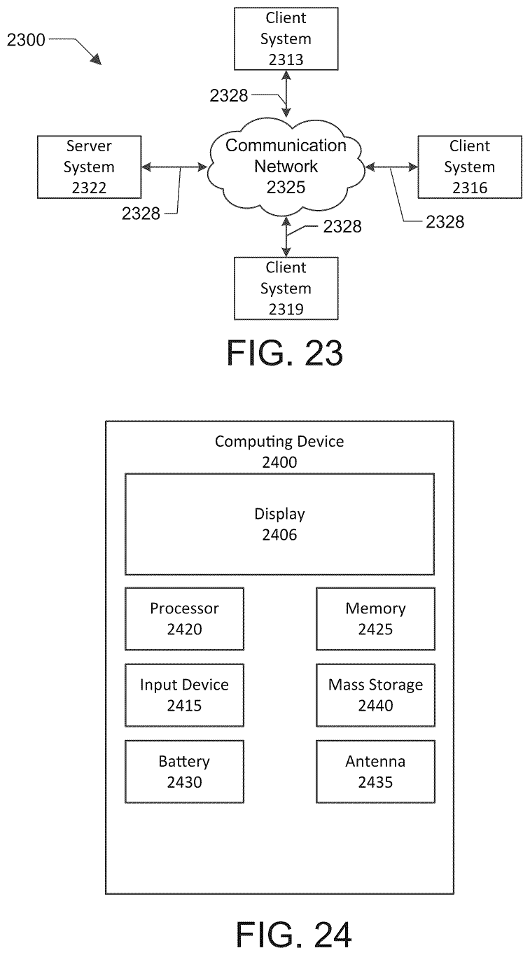

FIG. 23 is an exemplary block diagram depicting an embodiment of a system for implementing embodiments of methods of the disclosure, e.g., as described with reference to the previous figures. In FIG. 23, distributed computer network system 2300 includes a number of computing devices, e.g., client systems 2313, 2316, 2319, and one or more server systems 2322 coupled to a communication network 2325 via a plurality of communication links 2328. Communication network 2325 provides a mechanism for allowing the various components of distributed network 2300 to communicate and exchange information with each other. Thus, FIG. 23 describes systems, e.g., client systems 2313, 2316, 2319, for implementing elements of the above disclosure, e.g., controllers of systems 100, 700, 1000, 1100, 1300, 1400.

Communication network 2325 itself is comprised of one or more interconnected computer systems and communication links. Communication links 2328 may include hardwire links, optical links, satellite or other wireless communications links, wave propagation links, or any other mechanisms for communication of information. Various communication protocols may be used to facilitate communication between the various systems shown in FIG. 23. These communication protocols may include TCP/IP, UDP, HTTP protocols, wireless application protocol (WAP), BLUETOOTH, Zigbee, 802.11, 802.15, 6LoWPAN, LiFi, Google Weave, NFC, GSM, CDMA, other cellular data communication protocols, wireless telephony protocols, Internet telephony, IP telephony, digital voice, voice over broadband (VoBB), broadband telephony, Voice over IP (VoIP), vendor-specific protocols, customized protocols, and others. While in one embodiment, communication network 2325 is the Internet, in other embodiments, communication network 2325 may be any suitable communication network including a local area network (LAN), a wide area network (WAN), a wireless network, a cellular network, a personal area network, an intranet, a private network, a near field communications (NFC) network, a public network, a switched network, a peer-to-peer network, and combinations of these, and the like.

In an embodiment, the server 2322 is not located near a user of a computing device, and is communicated with over a network. In a different embodiment, the server 2322 is a device that a user can carry upon his person, or can keep nearby. In an embodiment, the server 2322 has a large battery to power long distance communications networks such as a cell network (LTE, 5G), or Wi-Fi. The server 2322 communicates with the other components of the system via wired links or via low powered short-range wireless communications such as Bluetooth®. In an embodiment, one of the other components of the system plays the role of the server, e.g., the client system 2313.

Distributed computer network 2300 in FIG. 23 is merely illustrative of an embodiment incorporating the embodiments and does not limit the scope of the invention as recited in the claims. One of ordinary skill in the art would recognize other variations, modifications, and alternatives. For example, more than one server system 2322 may be connected to communication network 2325. As another example, a number of computing devices 2313, 2316, 2319 may be coupled to communication network 2325 via an access provider (not shown) or via some other server system.

Computing devices 2313, 2316, 2319 typically request information from a server system that provides the information. Server systems by definition typically have more computing and storage capacity than these computing devices, which are often such things as portable devices, mobile communications devices, or other computing devices that play the role of a client in a client-server operation. However, a particular computing device may act as both a client and a server depending on whether the computing device is requesting or providing information. Aspects of the embodiments may be embodied using a client-server environment or a cloud-cloud computing environment.

Server 2322 is responsible for receiving information requests from computing devices 2313, 2316, 2319, for performing processing required to satisfy the requests, and for forwarding the results corresponding to the requests back to the requesting computing device. The processing required to satisfy the request may be performed by server system 2322 or may alternatively be delegated to other servers connected to communication network 2325 or to other communications networks. A server 2322 may be located near the computing devices 2313, 2316, 2319 or may be remote from the computing devices 2313, 2316, 2319. A server 2322 may be a hub controlling a local enclave of things in an internet of things scenario.

Computing devices 2313, 2316, 2319 may enable users to access and query information or applications stored by server system 2322. Some example computing devices include portable electronic devices (e.g., mobile communications devices) such as the Apple iPhone®, the Apple iPad®, the Palm Pre™, or any computing device running the Apple iOS™, Android™ OS, Google Chrome OS, Symbian OS®, Windows 10, Windows Mobile® OS, Palm OS® or Palm Web OS™, or any of various operating systems used for Internet of Things (IoT) devices or automotive or other vehicles or Real Time Operating Systems (RTOS), such as the RIOT OS, Windows 10 for IoT, WindRiver VxWorks, Google Brillo, ARM Mbed OS, Embedded Apple iOS and OS X, the Nucleus RTOS, Green Hills Integrity, or Contiki, or any of various Programmable Logic Controller (PLC) or Programmable Automation Controller (PAC) operating systems such as Microware OS-9, VxWorks, QNX Neutrino, FreeRTOS, Micrium pC/OS-II, Micrium pC/OS-III, Windows CE, TI-RTOS, RTEMS. Other operating systems may be used. In a specific embodiment, a “web browser” application executing on a computing device enables users to select, access, retrieve, or query information and/or applications stored by server system 2322. Examples of web browsers include the Android browser provided by Google, the Safari® browser provided by Apple, the Opera Web browser provided by Opera Software, the BlackBerry® browser provided by Research In Motion, the Internet Explorer® and Internet Explorer Mobile browsers provided by Microsoft Corporation, the Firefox® and Firefox for Mobile browsers provided by Mozilla®, and others.

FIG. 24 is an exemplary block diagram depicting a computing device 2400 for implementing embodiments of methods of the disclosure. Computing device 2400 may be any of the computing devices 2313, 2316, 2319 from FIG. 23. Computing device 2400 may include a display, screen, or monitor 2406, housing 2408, and input device 2415. Housing 2408 houses familiar computer components, some of which are not shown, such as a processor 2420, memory 2425, battery 2430, speaker, transceiver, antenna 2435, microphone, ports, jacks, connectors, camera, input/output (I/O) controller, display adapter, network interface, mass storage devices 2440, various sensors, and the like.

Input device 2415 may also include a touchscreen (e.g., resistive, surface acoustic wave, capacitive sensing, infrared, optical imaging, dispersive signal, or acoustic pulse recognition), keyboard (e.g., electronic keyboard or physical keyboard), buttons, switches, stylus, or combinations of these.

Mass storage devices 2440 may include flash and other nonvolatile solid-state storage or solid-state drive (SSD), such as a flash drive, flash memory, or USB flash drive. Other examples of mass storage include mass disk drives, floppy disks, magnetic disks, optical disks, magneto-optical disks, fixed disks, hard disks, SD cards, CD-ROMs, recordable CDs, DVDs, recordable DVDs (e.g., DVD-R, DVD+R, DVD-RW, DVD+RW, HD-DVD, or Blu-ray Disc), battery-backed-up volatile memory, tape storage, reader, and other similar media, and combinations of these.

Embodiments may also be used with computer systems having different configurations, e.g., with additional or fewer subsystems, and may include systems provided by Arduino, or Raspberry Pi. For example, a computer system could include more than one processor (i.e., a multiprocessor system, which may permit parallel processing of information) or a system may include a cache memory. The computer system shown in FIG. 24 is but an example of a computer system suitable for use with the embodiments. Other configurations of subsystems suitable for use with the embodiments will be readily apparent to one of ordinary skill in the art. For example, in a specific implementation, the computing device is a mobile communications device such as a smartphone or tablet computer. Some specific examples of smartphones include the Droid Incredible and Google Nexus One, provided by HTC Corporation, the iPhone or iPad, both provided by Apple, and many others. The computing device may be a laptop or a netbook. In another specific implementation, the computing device is a non-portable computing device such as a desktop computer or workstation.

A computer-implemented or computer-executable version of the program instructions useful to practice the embodiments may be embodied using, stored on, or associated with computer-readable medium. A computer-readable medium may include any medium that participates in providing instructions to one or more processors for execution, such as memory 2425 or mass storage 2440. Such a medium may take many forms including, but not limited to, nonvolatile, volatile, transmission, non-printed, and printed media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software useful to practice the embodiments may be stored or reside in RAM or cache memory, or on mass storage device 2440. The source code of this software may also be stored or reside on mass storage device 2440 (e.g., flash drive, hard disk, magnetic disk, tape, or CD-ROM). As a further example, code useful for practicing the embodiments may be transmitted via wires, radio waves, or through a network such as the Internet. In another specific embodiment, a computer program product including a variety of software program code to implement features of the embodiment is provided.

Computer software products may be written in any of various suitable programming languages, such as C, C++, C#, Pascal, Fortran, Perl, Matlab (from MathWorks, www.mathworks.com), SAS, SPSS, JavaScript, CoffeeScript, Objective-C, Swift, Objective-J, Ruby, Rust, Python, Erlang, Lisp, Scala, Clojure, and Java. The computer software product may be an independent application with data input and data display modules. Alternatively, the computer software products may be classes that may be instantiated as distributed objects. The computer software products may also be component software such as Java Beans (from Oracle) or Enterprise Java Beans (EJB from Oracle).

An operating system for the system may be the Android operating system, iPhone OS (i.e., iOS), Symbian, BlackBerry OS, Palm web OS, Bada, MeeGo, Maemo, Limo, or Brew OS. Other examples of operating systems include one of the Microsoft Windows family of operating systems (e.g., Windows 95, 98, Me, Windows NT, Windows 2000, Windows XP, Windows XP x64 Edition, Windows Vista, Windows 10 or other Windows versions, Windows CE, Windows Mobile, Windows Phone, Windows 10 Mobile), Linux, HP-UX, UNIX, Sun OS, Solaris, Mac OS X, Alpha OS, AIX, IRIX32, or IRIX64, or any of various operating systems used for Internet of Things (IoT) devices or automotive or other vehicles or Real Time Operating Systems (RTOS), such as the RIOT OS, Windows 10 for IoT, WindRiver VxWorks, Google Brillo, ARM Mbed OS, Embedded Apple iOS and OS X, the Nucleus RTOS, Green Hills Integrity, or Contiki, or any of various Programmable Logic Controller (PLC) or Programmable Automation Controller (PAC) operating systems such as Microware OS-9, VxWorks, QNX Neutrino, FreeRTOS, Micrium pC/OS-II, Micrium pC/OS-III, Windows CE, TI-RTOS, RTEMS. Other operating systems may be used.

Furthermore, the computer may be connected to a network and may interface to other computers using this network. The network may be an intranet, internet, or the Internet, among others. The network may be a wired network (e.g., using copper, and connections such as RS232 connectors), telephone network, packet network, an optical network (e.g., using optical fiber), or a wireless network, or any combination of these. For example, data and other information may be passed between the computer and components (or steps) of a system useful in practicing the embodiments using a wireless network employing a protocol such as Wi-Fi (IEEE standards 802.11, 802.1a, 802.11b, 802.11e, 802.11g, 802.11i, and 802.11n, just to name a few examples), or other protocols, such as BLUETOOTH or NFC or 802.15 or cellular, or communication protocols may include TCP/IP, UDP, HTTP protocols, wireless application protocol (WAP), BLUETOOTH, Zigbee, 802.11, 802.15, 6LoWPAN, LiFi, Google Weave, NFC, GSM, CDMA, other cellular data communication protocols, wireless telephony protocols or the like. For example, signals from a computer may be transferred, at least in part, wirelessly to components or other computers.

The following include a set A of enumerated embodiments.
Embodiment A1. A sound generation device, comprising: a spinning disc with a modulated hole pattern; a mechanism for controlled airflow through said disc; and a motor assembly configured to modulate the spinning of the disc, wherein the motor assembly includes at least one stepper motor and a motor/encoder combination.
Embodiment A2. The device of embodiment A1, wherein the hole pattern on the spinning disc is adjustable to produce different sound frequencies and patterns.
Embodiment A3. The embodiment A1 or A2, wherein the sound frequencies and patterns are configured for extinguishing fires by targeting specific fire fundamental and harmonic frequencies.
Embodiment A4. A method for extinguishing a fire, comprising: generating sound waves using a spinning disc with a hole pattern as described in claim 1; directing the sound waves toward a fire; and modulating the sound waves to align with the fire's fundamental and harmonic frequencies to achieve a pyrosonic lock.
Embodiment A5. The method of embodiment A4, wherein the modulation of sound waves includes varying the speed of the spinning disc through the motor assembly.
Embodiment A6. A sound-based fire extinguishing system, comprising: a sound generation unit as described in embodiment A1: a targeting mechanism to direct sound towards a fire; and a control system configured to adjust sound frequency and pattern to achieve fire extinguishment.
Embodiment A7. The system of embodiment A6, wherein the control system is configured to identify and target the fundamental and harmonic frequencies of the fire.
Embodiment A8. The device of embodiment A1, further comprises a configuration for generating musical notes and melodies.
Embodiment A9. A method for generating sound below the human hearing range, employing the device of embodiment A1, wherein the sound is utilized for purposes other than audible entertainment.
Embodiment A10. The method of embodiment A 9, wherein the sound generated is used for fire suppression.

The following include a set B of enumerated embodiments.
Embodiment B1, a sound-generating system, comprising: a housing; a first plate containing a first pattern of openings, the first plate provided within the housing and rotatable about an axis; a motor configured to rotate the first plate; a controller connected to the motor and configured to control the speed of rotation of the motor; a blower capable of providing an airflow and connected to the housing such that the airflow, when provided, is directed to the first plate through the housing, wherein: when the blower is providing the airflow and the controller is causing the motor to rotate the first plate at a first speed, a first sound of a first frequency is produced; and when the blower is providing the airflow and the controller is causing the motor to rotate the first plate at a second speed, a second sound of a second frequency is produced.
Embodiment B2. The sound-generating system of Embodiment B1, wherein: the first plate is replaceable with a second plate provided with a second pattern of openings; and when the first plate is replaced with the second plate, the blower is providing the airflow, and the controller is causing the motor to rotate the second plate at the first speed, a third sound of a third frequency is produced; and when the first plate is replaced with the second plate, the blower is providing the airflow, and the controller is causing the motor to rotate the second plate at the second speed, a fourth sound of a fourth frequency is produced.
Embodiment B3. The sound-generating system of Embodiment B1, further including a second plate containing a second pattern of openings and provided within the housing such that the airflow passes through both the first pattern of openings and the second pattern of openings when rotation of the first plate causes at least part of the first pattern of openings to overlap at least part of the second pattern of openings.
Embodiment B4. The sound-generating system of Embodiment B3, wherein the controller is configured to modulate rotation speed of the first plate according to a pre-defined sequence such that, when the blower is providing the airflow and the controller is modulating rotation speed of the first plate according to the pre-defined sequence, a predetermined pattern of sound frequencies is produced by the system.
Embodiment B5. The sound-generating system of Embodiment B4, wherein the pre-defined pattern of sounds is configured to extinguish fire.
Embodiment B6. The sound-generating system of Embodiment B5, wherein the pre-defined pattern of sounds includes a descending chirp.
Embodiment B7. The sound-generating system of Embodiment B6, further comprising: a sleeve having a nozzle and extending from the housing, the airflow flowing from the housing through the sleeve and exiting the sleeve through the nozzle; a tube connecting the blower to the housing; a handle; and a power supply.
Embodiment B8. The sound-generating system of Embodiment B3, wherein the controller is configured to modulate rotation speed of the first plate according to input received from a user interface, wherein: the controller causing the motor to rotate the first plate at a first speed includes the controller causing the motor to rotate the first plate at the first speed after receiving a first input from the user interface; and the controller is causing the motor to rotate the first plate at the second speed includes the controller causing the motor to rotate the first plate at the second speed after receiving a second input from the user interface.
Embodiment B9. The sound-generating system of Embodiment B8, wherein the user interface includes a keyboard, a first key of the keyboard providing the first input when activated, and a second key of the keyboard providing the second input when activated.
Embodiment B10. A method for generating sounds at different frequencies, comprising: directing an airflow through a first plate containing a first pattern of openings, the first plate provided within a housing and rotatable about an axis; controlling the speed of a motor configured to rotate the first plate to cause the motor to rotate the first plate at a first speed such that the airflow through the first pattern of openings produces a first sound of a first frequency is produced; and controlling the speed of the motor to cause the motor to rotate the first plate at a second speed such that the airflow through the first pattern of openings produces a second sound of a second frequency.
Embodiment B11. The method of Embodiment B10, wherein a second plate containing a second pattern of openings is provided within the housing such that the airflow passes through both the first pattern of openings and the second pattern of openings when rotation of the first plate causes at least part of the first pattern of openings to overlap at least part of the second pattern of openings.
Embodiment B12. The method of Embodiment B11, further comprising: modulating rotation speed of the first plate according to a pre-defined sequence such that a predetermined pattern of sound frequencies is produced by the system.
Embodiment B13. The method of Embodiment B12, wherein the pre-defined pattern of sounds is configured to extinguish fire.
Embodiment B14. The method of Embodiment B13, wherein the pre-defined pattern of sounds includes a descending chirp.
Embodiment B15. The method of Embodiment B11, further including modulating rotation speed of the first plate according to input received from a user interface, wherein: causing the motor to rotate the first plate at a first speed includes causing the motor to rotate the first plate at the first speed after receiving a first input from the user interface; and causing the motor to rotate the first plate at the second speed includes causing the motor to rotate the first plate at the second speed after receiving a second input from the user interface.
Embodiment B16. The method of Embodiment B15, wherein the user interface includes a keyboard, a first key of the keyboard providing the first input when activated, and a second key of the keyboard providing the second input when activated.
Embodiment B17. A non-transitory, computer-readable storage medium having stored thereon a plurality of instructions, which, when executed by a processor of a controller of a sound-generating system, cause the sound-generating system to: direct an airflow through a first plate containing a first pattern of openings, the first plate provided within a housing and rotatable about an axis; control the speed of a motor to cause the motor to rotate the first plate at a first speed such that the airflow through the first pattern of openings produces a first sound of a first frequency is produced: and control the speed of the motor to cause the motor to rotate the first plate at a second speed such that the airflow through the first pattern of openings produces a second sound of a second frequency.
Embodiment B18. The non-transitory, computer-readable storage medium of Embodiment B17, wherein a second plate containing a second pattern of openings is provided within the housing such that the airflow passes through both the first pattern of openings and the second pattern of openings when rotation of the first plate causes at least part of the first pattern of openings to overlap at least part of the second pattern of openings.
Embodiment B19. The non-transitory, computer-readable storage medium of Embodiment B17, the instructions further causing the sound-generating system to: modulate rotation speed of the first plate according to a pre-defined sequence such that a predetermined pattern of sound frequencies is produced by the system.
Embodiment B20. The non-transitory, computer-readable storage medium of Embodiment B12, wherein the pre-defined pattern of sounds is configured to extinguish fire.

The previous description is provided to enable any person skilled in the art to practice the various aspects described herein. In the embodiments, the separation of various system components in the embodiments described above should not be understood as requiring such separation in all embodiments. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims.

What is claimed is:

1. A sound-generating system, comprising:
a housing;
a first plate containing a first pattern of openings, the first plate provided within the housing and rotatable about an axis;
a motor configured to rotate the first plate;
a controller connected to the motor and configured to control the speed of rotation of the motor;
a blower capable of providing an airflow and connected to the housing such that the airflow, when provided, is directed to the first plate through the housing, wherein:
when the blower is providing the airflow and the controller is causing the motor to rotate the first plate at a first speed, a first sound of a first frequency is produced; and
when the blower is providing the airflow and the controller is causing the motor to rotate the first plate at a second speed, a second sound of a second frequency is produced.

2. The sound-generating system of claim 1, wherein:
the first plate is replaceable with a second plate provided with a second pattern of openings; and
when the first plate is replaced with the second plate, the blower is providing the airflow, and the controller is causing the motor to rotate the second plate at the first speed, a third sound of a third frequency is produced; and
when the first plate is replaced with the second plate, the blower is providing the airflow, and the controller is causing the motor to rotate the second plate at the second speed, a fourth sound of a fourth frequency is produced.

3. The sound-generating system of claim 1, further including a second plate containing a second pattern of openings and provided within the housing such that the airflow passes through both the first pattern of openings and the second pattern of openings when rotation of the first plate causes at least part of the first pattern of openings to overlap at least part of the second pattern of openings.

4. The sound-generating system of claim 3, wherein the controller is configured to modulate rotation speed of the first plate according to a pre-defined sequence such that, when the blower is providing the airflow and the controller is modulating rotation speed of the first plate according to the pre-defined sequence, a predetermined pattern of sound frequencies is produced by the system.

5. The sound-generating system of claim 4, wherein the pre-defined pattern of sounds is configured to extinguish fire.

6. The sound-generating system of claim 5, wherein the pre-defined pattern of sounds includes a descending chirp.

7. The sound-generating system of claim 6, further comprising:
a sleeve having a nozzle and extending from the housing, the airflow flowing from the housing through the sleeve and exiting the sleeve through the nozzle;
a tube connecting the blower to the housing;
a handle; and
a power supply.

8. The sound-generating system of claim 3, wherein the controller is configured to modulate rotation speed of the first plate according to input received from a user interface, wherein:
the controller causing the motor to rotate the first plate at a first speed includes the controller causing the motor to rotate the first plate at the first speed after receiving a first input from the user interface; and
the controller is causing the motor to rotate the first plate at the second speed includes the controller causing the motor to rotate the first plate at the second speed after receiving a second input from the user interface.

9. The sound-generating system of claim 8, wherein the user interface includes a keyboard, a first key of the keyboard providing the first input when activated, and a second key of the keyboard providing the second input when activated.

10. A method for generating sounds at different frequencies, comprising:
directing an airflow through a first plate containing a first pattern of openings, the first plate provided within a housing and rotatable about an axis;
controlling the speed of a motor configured to rotate the first plate to cause the motor to rotate the first plate at a first speed such that the airflow through the first pattern of openings produces a first sound of a first frequency is produced; and
controlling the speed of the motor to cause the motor to rotate the first plate at a second speed such that the airflow through the first pattern of openings produces a second sound of a second frequency.

11. The method of claim 10, wherein a second plate containing a second pattern of openings is provided within the housing such that the airflow passes through both the first pattern of openings and the second pattern of openings when rotation of the first plate causes at least part of the first pattern of openings to overlap at least part of the second pattern of openings.

12. The method of claim 11, further comprising:
modulating rotation speed of the first plate according to a pre-defined sequence such that a predetermined pattern of sound frequencies is produced by the system.

13. The method of claim 12, wherein the pre-defined pattern of sounds is configured to extinguish fire.

14. The method of claim 13, wherein the pre-defined pattern of sounds includes a descending chirp.

15. The method of claim 11, further including modulating rotation speed of the first plate according to input received from a user interface, wherein:
causing the motor to rotate the first plate at a first speed includes causing the motor to rotate the first plate at the first speed after receiving a first input from the user interface; and
causing the motor to rotate the first plate at the second speed includes causing the motor to rotate the first plate at the second speed after receiving a second input from the user interface.

16. The method of claim 15, wherein the user interface includes a keyboard, a first key of the keyboard providing the first input when activated, and a second key of the keyboard providing the second input when activated.

17. A non-transitory, computer-readable storage medium having stored thereon a plurality of instructions, which, when executed by a processor of a controller of a sound-generating system, cause the sound-generating system to:
direct an airflow through a first plate containing a first pattern of openings, the first plate provided within a housing and rotatable about an axis;
control the speed of a motor to cause the motor to rotate the first plate at a first speed such that the airflow through the first pattern of openings produces a first sound of a first frequency is produced; and
control the speed of the motor to cause the motor to rotate the first plate at a second speed such that the airflow through the first pattern of openings produces a second sound of a second frequency.

18. The non-transitory, computer-readable storage medium of claim 17, wherein a second plate containing a second pattern of openings is provided within the housing such that the airflow passes through both the first pattern of openings and the second pattern of openings when rotation of the first plate causes at least part of the first pattern of openings to overlap at least part of the second pattern of openings.

19. The non-transitory, computer-readable storage medium of claim 17, the instructions further causing the sound-generating system to:
modulate rotation speed of the first plate according to a pre-defined sequence such that a predetermined pattern of sound frequencies is produced by the system.

20. The non-transitory, computer-readable storage medium of claim 19, wherein the pre-defined pattern of sounds is configured to extinguish fire.
